(19) United States
(12) Patent Application Publication
(10) Pub. No.: US 2025/0016753 A1
(43) Pub. Date: Jan. 9, 2025

(54) METHODS AND APPARATUSES FOR A RESOURCE ALLOCATION IN A SUB-BAND FULL DUPLEX SCENARIO

(71) Applicant: LENOVO (BEIJING) LIMITED, Beijing (CN)

(72) Inventors: Ruixiang MA, Beijing (CN); Yuantao ZHANG, Beijing (CN); Haiming WANG, Beijing (CN)

(21) Appl. No.: 18/712,068

(22) PCT Filed: Nov. 22, 2021
(86) PCT No.: PCT/CN2021/132055

§ 371 Date: May 21, 2024

(51) Int. Cl. H04W 72/0453; H04L 5/14; H04W 72/0446

(52) U.S. Cl. CPC H04W 72/0453; H04L 5/14; H04W 72/0446

(57) ABSTRACT

Embodiments of the present application relate to methods and apparatuses for a resource allocation scheme in a sub-band full duplex scenario. According to an embodiment of the present application, a UE includes a processor and a transceiver coupled to the processor; and the processor is configured: to receive, via the transceiver from a network node, at least one indication indicating at least one frequency domain transmission resource; and to determine a frequency domain resource in a time unit according to a type of the time unit, wherein the frequency domain resource is used for transmitting a physical uplink share channel (PUSCH) transmission, wherein the frequency domain resource is associated with the at least one frequency domain transmission resource, and wherein the type of the time unit comprises a time unit type or a further time unit type.

### TECHNICAL FIELD

Embodiments of the present application generally relate to wireless communication technology, in particular to methods and apparatuses for a resource allocation scheme in a sub-band full duplex scenario.

### BACKGROUND

In general, regarding new radio (NR) resource allocation as specified in 3GPP (3rd Generation Partnership Project) standard documents, physical uplink share channel (PUSCH) transmission(s) can be dynamically scheduled by an uplink (UL) grant in downlink control information (DCI), or the transmission can correspond to a configured grant (CG) Type 1 or CG Type 2. The CG Type 1 PUSCH transmission may be semi-statically configured to operate upon the reception of higher layer parameter of configuredGrantConfig including rrc-ConfiguredUplinkGrant without the detection of an UL grant in DCI. The CG Type 2 PUSCH transmission may be semi-persistently scheduled by an UL grant in a valid activation DCI after the reception of higher layer parameter configuredGrantConfig not including rrc-ConfiguredUplinkGrant.

Before a NR UE transmits a PUSCH transmission, including a dynamic scheduled PUSCH transmission and a CG PUSCH transmission, the NR UE receives frequency domain resource allocation assignment and time domain resource assignment from a NR base station (BS), to determine the frequency and time domain resource of the PUSCH transmission.

Regarding a sub-band full duplex scenario, in order to realize the superior data rate and latency, 3GPP 5G spectrum on higher frequency band is inevitable. But an issue needs to be solved is how to overcome the coverage reduction on such carriers. 3GPP Rel-18 will probably introduce a new duplexing scheme that enables simultaneous use of downlink (DL) and uplink (UL) within a time division dual (TDD) carrier using non-overlapped frequency domain resource(s), which could be named as sub-band full duplex, while another name is not excluded. The intention of this scheme is to extend the duration over which uplink transmission could occur for improved the uplink coverage and capacity. The simultaneous use of DL and UL is only at a BS side but not at a UE side. An example of sub-band full duplex scheme could be seen in FIG. 1F.

Currently, details regarding a resource allocation scheme in a sub-band full duplex scenario have not been discussed yet.

### SUMMARY

Some embodiments of the present application also provide a UE. The UE includes a processor and a transceiver coupled to the processor; and the processor is configured: to receive, via the transceiver from a network node, at least one indication indicating at least one frequency domain transmission resource; and to determine a frequency domain resource in a time unit according to a type of the time unit, wherein the frequency domain resource is used for transmitting a PUSCH transmission, wherein the frequency domain resource is associated with the at least one frequency domain transmission resource, and wherein the type of the time unit comprises a time unit type or a further time unit type.

Some embodiments of the present application provide a method, which may be performed by a UE. The method includes: receiving, from a network node, at least one indication indicating at least one frequency domain transmission resource; and determining a frequency domain resource in a time unit according to a type of the time unit, wherein the frequency domain resource is used for transmitting a PUSCH transmission, wherein the frequency domain resource is associated with the at least one frequency domain transmission resource, and wherein the type of the time unit comprises a time unit type or a further time unit type.

Some embodiments of the present application also provide a UE. The UE includes a processor and a transceiver coupled to the processor; and the processor is configured: to receive, via the transceiver from a network node, an indication indicating a frequency domain transmission resource; and to determine whether to transmit a PUSCH transmission on the frequency domain transmission resource or not in a time unit according to a type of the time unit, wherein the type of the time unit comprises a time unit type or a further time unit type.

Some embodiments of the present application provide a method, which may be performed by a UE. The method includes: receiving, from a network node, an indication indicating a frequency domain transmission resource; and determining whether to transmit a PUSCH transmission on the frequency domain transmission resource or not in a time unit according to a type of the time unit, wherein the type of the time unit comprises a time unit type or a further time unit type.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a UE.

Some embodiments of the present application also provide a network node (e.g., a base station (BS)). The network node includes a processor and a transceiver coupled to the processor; and the processor is configured: to transmit, via the transceiver to a UE, at least one indication indicating at least one frequency domain transmission resource; and to determine a frequency domain resource in a time unit according to a type of the time unit, wherein the frequency domain resource is used for receiving a PUSCH transmission, wherein the frequency domain resource is associated with the at least one frequency domain transmission resource, and wherein the type of the time unit comprises a time unit type or a further time unit type.

Some embodiments of the present application provide a method, which may be performed by a network node (e.g., a BS). The method includes: transmitting, to a UE, at least one indication indicating at least one frequency domain transmission resource; and determining a frequency domain resource in a time unit according to a type of the time unit, wherein the frequency domain resource is used for receiving a PUSCH transmission, wherein the frequency domain resource is associated with the at least one frequency domain transmission resource, and wherein the type of the time unit comprises a time unit type or a further time unit type.

Some embodiments of the present application also provide a network node (e.g., a BS). The network node includes a processor and a transceiver coupled to the processor; and the processor is configured: to transmit, via the transceiver to a UE, an indication indicating a frequency domain transmission resource; and to determine whether to receive a PUSCH transmission on the frequency domain transmission resource or not in a time unit according to a type of the time unit, wherein the type of the time unit comprises a time unit type or a further time unit type.

Some embodiments of the present application provide a method, which may be performed by a network node (e.g., a BS). The method includes: transmitting, to a UE, an indication indicating a frequency domain transmission resource; and determining whether to receive a PUSCH transmission on the frequency domain transmission resource or not in a time unit according to a type of the time unit, wherein the type of the time unit comprises a time unit type or a further time unit type.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1A illustrates an exemplary wireless communication system according to some embodiments of the present disclosure;

FIG. 1B illustrates an example for a PUSCH transmission with PUSCH repetition Type A according to some embodiments of the present disclosure;

FIG. 1C illustrates an example for a PUSCH transmission with PUSCH repetition Type B according to some embodiments of the present disclosure;

FIG. 1D illustrates an example for a PUSCH transmission with enhanced PUSCH repetition Type A according to some embodiments of the present disclosure;

FIG. 1E illustrates an example for a PUSCH transmission with TBOMS according to some embodiments of the present disclosure;

FIG. 1F illustrates an example for a sub-band full duplex scenario according to some embodiments of the present disclosure;

FIG. 1G illustrates an example for a frequency domain resource crossing multiple frequency domain sub-bands configured with different transmission directions according to some embodiments of the present disclosure;

FIG. 2 illustrates an exemplary block diagram of an apparatus according to some embodiments of the present application;

FIG. 3 illustrates an exemplary flow chart of a method for receiving an indication indicating a frequency domain transmission resource according to some embodiments of the present application;

FIG. 4 illustrates a further exemplary flow chart of a method for receiving an indication indicating a frequency domain transmission resource according to some embodiments of the present application;

FIG. 5 illustrates an exemplary flow chart of a method for transmitting an indication indicating a frequency domain transmission resource according to some embodiments of the present application;

FIG. 6 illustrates a further exemplary flow chart of a method for transmitting an indication indicating a frequency domain transmission resource according to some embodiments of the present application;

FIG. 7 illustrates an exemplary resource allocation scheme for CG PUSCH transmission without repetition according to some embodiments of the present application;

FIG. 8 illustrates an exemplary resource allocation scheme for PUSCH transmission with PUSCH repetition Type A according to some embodiments of the present application;

FIGS. 9A, 9B, and 9C illustrate exemplary resource allocation schemes for PUSCH transmission with PUSCH repetition Type B according to some embodiments of the present application;

FIG. 10 illustrates an exemplary resource allocation scheme for PUSCH transmission with enhanced PUSCH repetition Type A and TBOMS according to some embodiments of the present application;

FIG. 11 illustrates an exemplary resource allocation scheme for CG PUSCH transmission without repetition according to some embodiments of the present application;

FIGS. 12 and 13 illustrates exemplary resource allocation schemes for PUSCH with PUSCH repetition Type A or enhanced PUSCH repetition Type A according to some embodiments of the present application;

FIGS. 14A and 14B illustrate exemplary resource allocation schemes for PUSCH with PUSCH repetition Type B according to some embodiments of the present application;

FIGS. 15A and 15B illustrate exemplary resource allocation schemes for PUSCH with PUSCH repetition Type B according to some embodiments of the present application;

FIGS. 16 and 17 illustrate exemplary resource allocation schemes for PUSCH with PUSCH repetition Type B according to some embodiments of the present application;

FIGS. 18 and 19 illustrate exemplary resource allocation schemes for PUSCH with TBOMS according to some embodiments of the present application;

FIGS. 20 and 21 illustrate exemplary resource allocation schemes for CG PUSCH transmission without repetition according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

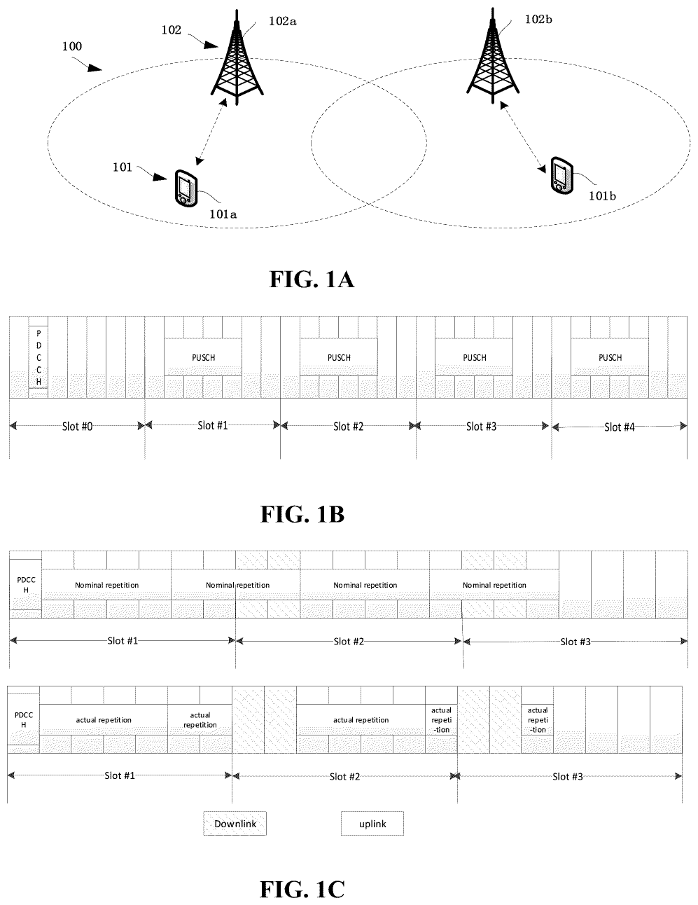

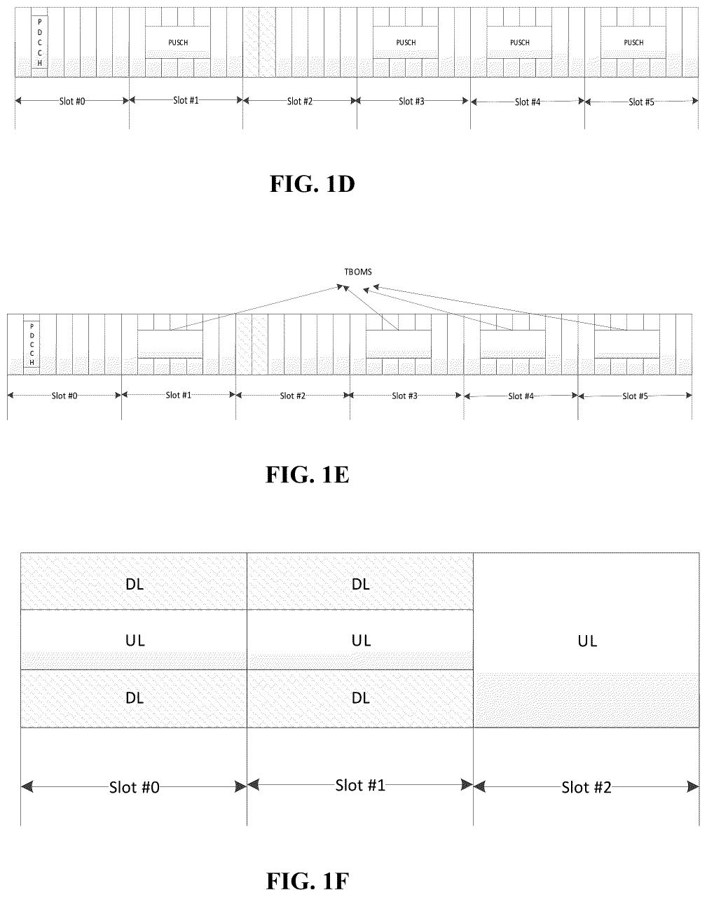

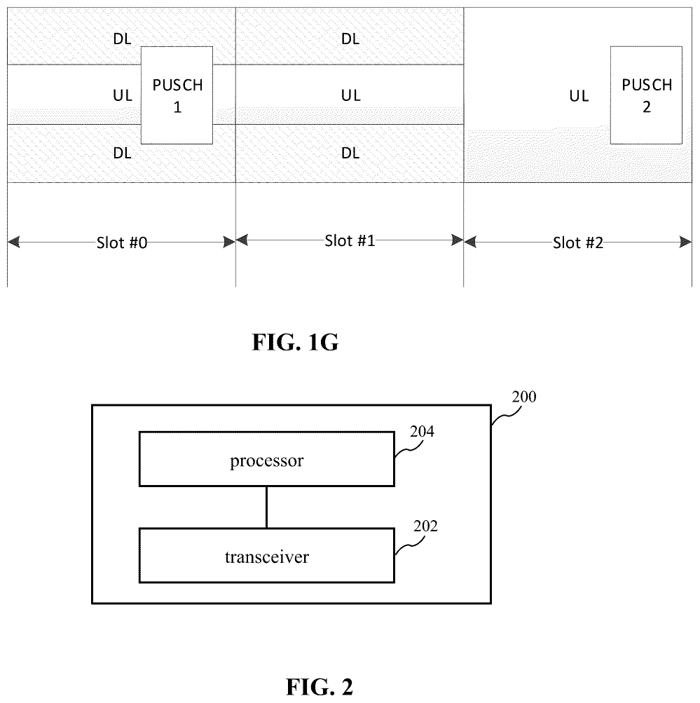

FIG. 1A illustrates an exemplary wireless communication system according to some embodiments of the present disclosure.

As shown in FIG. 1A, the wireless communication system 100 includes at least one user equipment (UE) 101 and at least one base station (BS) 102. In particular, the wireless communication system 100 includes two UEs 101, e.g., UE 101a and UE 101b, and two BSs 102, e.g., BS 102a and BS 102b, for illustrative purpose. Although a specific number of UE(s) 101 and BS(s) 102 are depicted in FIG. 1A, one skilled in the art will recognize that any number of UE(s) 101 and BS(s) 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 101 include wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BS(s) 102 via uplink (UL) communication signals.

BS(s) 102 may be distributed over a geographic region. In certain embodiments of the present disclosure, each of BS(s) 102 may also be referred to as an access point, an access terminal, a base, a macro cell, a Node-B, an evolved Node B (eNB), a gNB, a Home Node-B, a relay node, or a device, or described using other terminology used in the art. BS(s) 102 is generally part of a radio access network that may include one or more controllers communicably coupled to one or more corresponding BS(s) 102.

The wireless communication system 100 is compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3rd Generation Partnership Project (3GPP)-based network, a 3GPP 5G network, a satellite communications network, a high altitude platform network, and/or other communications networks.

In an embodiment of the present disclosure, the wireless communication system 100 is compatible with the 5G NR of the 3GPP protocol, wherein BS(s) 102 transmits data using an orthogonal frequency division multiplexing (OFDM) modulation scheme on the DL, and UE(s) 101 transmits data on the uplink (UL) using a single-carrier frequency division multiple access (SC-FDMA) or OFDM scheme. More generally, however, the wireless communication system 100 may implement some other open or proprietary communication protocols, for example, WiMAX, among other protocols.

In another embodiment of the present disclosure, BS(s) 102 may communicate using other communication protocols, such as the IEEE 802.11 family of wireless communication protocols. Further, in some embodiments of the present disclosure, BS(s) 102 may communicate over licensed spectrums, whereas in other embodiments BS(s) 102 may communicate over unlicensed spectrums. The present disclosure is not intended to be limited to the implementation of any particular wireless communication system architecture or protocol. In yet another embodiment of present disclosure, BS(s) 102 may communicate with UE(s) 101 using the 3GPP 5G protocols.

Following text describes some current background of current resource allocation schemes according to agreements of 3GPP standard documents.

In particular, regarding a resource allocation in frequency domain, for dynamically scheduled PUSCH and CG Type 2 PUSCH, a UE shall determine a resource assignment using a resource allocation field in the detected physical downlink control channel (PDCCH) DCI. However, for CG Type 1 PUSCH, a resource assignment applied for the transmission is provided by higher layer parameter frequencyDomainAllocation in configuredGrantConfig. The frequency domain resource assignment indicates to a scheduled UE a set of resource blocks (RB) within the active bandwidth part. The RB indexing for resource allocation is determined within the UE's active bandwidth part.

Regarding a resource allocation in time domain, for dynamically scheduled PUSCH transmission(s), the ‘Time domain resource assignment’ field value m of the DCI provides a row index m+1 to an allocated table, and the used resource allocation table could be predefined by 3GPP specification or could be configured by a higher layer parameter. The indexed row defines the slot offset K₂, the start and length indicator SLIV, or directly the start symbol S and the allocation length L, and the number of repetitions (if memberOfRepetitions is present in the resource allocation table) to be applied in the PUSCH transmission. Where, slot offset K₂ is used to indicate the number of slots between the DCI received slot and PUSCH transmitted slot.

There may be four mainly resource allocation schemes in time domain of dynamically scheduled PUSCH, which include: (1) PUSCH repetition Type A introduced in 3GPP Rel-15; and (2) PUSCH repetition Type B introduced in 3GPP Rel-16; (3) enhanced PUSCH repetition Type A introduced in 3GPP Rel-17; and (4) transmission block processing over multi-slot PUSCH (TBOMS) introduced in 3GPP Rel-17. The enhanced PUSCH repetition Type A is beneficial for PUSCH coverage enhancements for TDD. The TBOMS is beneficial for PUSCH coverage enhancements. For a certain PUSCH transmission, higher layer parameter(s) could configure “which resource allocation scheme among these four schemes is used”. These four resource allocation schemes in time domain are specifically described as below, respectively.

### (1) PUSCH Repetition Type A

In particular, for PUSCH repetition Type A, the starting symbol S relative to the start of the slot, and the number of consecutive symbols L counting from the symbol S allocated for the PUSCH are determined from the start and length indicator SLIV of the indexed row:

$$if ( L - 1 ) \leq 7 then$$

$$SLIV = 14 \cdot ( L - 1 ) + S$$

$$else$$

$$SLIV = 14 \cdot ( 14 - L + 1 ) + ( 14 - 1 - S )$$

$$where 0 < L \leq 14 - S .$$

When transmitting PUSCH scheduled by DCI format 0_1 or 0_2 in PDCCH with cyclic redundancy check (CRC) scrambled with C-RNTI, MCS-C-RNTI, or CS-RNTI with NDI=1, the number of repetitions K is determined as:
if memberOfRepetitions is present in the resource allocation table, the number of repetitions K is equal to memberOfRepetitions;
else if the UE is configured with pusch-AggregationFactor, the number of repetitions K is equal to pusch-AggregationFactor;
otherwise K=1.

For PUSCH repetition Type A, in case K>1, the same symbol allocation is applied across the K consecutive slots. The UE shall repeat the transmission block (TB) across the K consecutive slots applying the same symbol allocation in each slot.

FIG. 1B illustrates an example for a PUSCH transmission with PUSCH repetition Type A according to some embodiments of the present disclosure. The embodiments of FIG. 1B assume that K₂=1, S=2, L=8, K=4. The time domain resources for a PUSCH transmission with PUSCH repetition Type A are shown in FIG. 1B. Each of five slots in FIG. 1B, i.e., Slot #0 to Slot #4, includes 14 symbols. As shown in FIG. 1B, each slot is divided into seven parts, and each part includes two symbols for illustrative purpose. In the embodiments of FIG. 1B, a PDCCH transmission is transmitted in Slot #0. Since S=2, each PUSCH transmission is transmitted from a start of the third symbol in a slot. Since K₂=1, the first PUSCH transmission in time domain is transmitted in Slot #1. Since K=4, there are four PUSCH transmissions transmitted in Slot #1, Slot #2, Slot #3, and Slot #4, respectively. Since L=8, each PUSCH transmission transmitted in Slot #1, Slot #2, Slot #3, and Slot #4 include 8 symbols.

For PUSCH repetition Type A, a PUSCH transmission in a slot of a multi-slot PUSCH transmission is omitted if any symbol of the PUSCH is overlapped with the set of symbols of the slot that are indicated to a UE as a DL by tdd-UL-DL-ConfigurationCommon, or tdd-UL-DL-ConfigurationDedicated.

### (2) PUSCH Repetition Type B

In particular, for PUSCH repetition Type B, the number of nominal repetitions is given by memberOfRepetitions. For the n-th nominal repetition, n=0, . . . , memberOfRepetitions−1,
The slot where the nominal repetition starts is given by

$${K}_{s} + ⌊ \frac{S + n \cdot L}{{N}_{symb}^{slot}} ⌋ ,$$

and the starting symbol relative to the start of the slot is given by mod (S+n·L,N_{symb}^{slot})
The slot where the nominal repetition ends is given by

$${K}_{s} + ⌊ \frac{S + ( n + 1 ) \cdot L - 1}{{N}_{symb}^{slot}} ⌋ ,$$

and the ending symbol relative to the start of the slot is given by mod (S+(n+1)·L−1,N_{symb}^{slot}).

Here K, is the slot where the PUSCH transmission starts, and N_{symb}^{slot} is the number of symbols per slot. The starting symbol S relative to the start of the slot, and the number of consecutive symbols L counting from the symbol S allocated for the PUSCH are provided by startSymbol and length of the indexed row of the resource allocation table, respectively.

For PUSCH repetition Type B, a symbol that is indicated as a DL by tdd-UL-DL-ConfigurationCommon, or tdd-UL-DL-ConfigurationDedicated, is considered as an invalid symbol for PUSCH repetition Type B transmission. After determining the invalid symbol(s) for PUSCH repetition Type B transmission for each of the K nominal repetitions, the remaining symbols are considered as potentially valid symbols for PUSCH repetition Type B transmission. If the number of potentially valid symbols for PUSCH repetition Type B transmission is greater than zero for a nominal repetition, the nominal repetition consists of one or more actual repetitions, where each actual repetition consists of a consecutive set of all potentially valid symbols that can be used for PUSCH repetition Type B transmission within a slot. An actual repetition with a single symbol is omitted except for the case of L=1.

An actual repetition is omitted if any symbol of the PUSCH is overlapped with the set of symbols of the slot that are indicated to a UE as a DL by tdd-UL-DL-ConfigurationCommon, or tdd-UL-DL-ConfigurationDedicated.

FIG. 1C illustrates an example for a PUSCH transmission with PUSCH repetition Type B according to some embodiments of the present disclosure. The embodiments of FIG. 1C assume that K₂=0, S=2, L=8, K=4, and then, the time domain resource for a PUSCH transmission with PUSCH repetition Type B could be seen in FIG. 1C. Each of three slots in FIG. 1C, i.e., Slot #1, Slot #2, or Slot #3, includes 14 symbols. As shown in FIG. 1C, each slot is divided into seven parts, and each part includes two symbols for illustrative purpose. In the embodiments of FIG. 1C, a PDCCH transmission is transmitted in Slot #1. Since K₂=0, the first nominal repetition of the PUSCH transmission in time domain is transmitted in Slot #1. Since S=2, the first nominal repetition is transmitted from a start of the third symbol in Slot #1. Since K=4, there are four nominal repetitions transmitted in Slot #1, Slot #2, and Slot #3, respectively. Since L=8, each nominal repetition PUSCH transmission includes 8 symbols, and all four nominal repetitions are consequent. As shown in FIG. 1C, since the first to fourth symbols in Slot #2 and the first to fourth symbols in Slot #3 are configured with a DL transmission direction, so the symbols in the first to fourth symbols in Slot #2 and the first to fourth symbols in Slot #3 are invalid symbols. That is, five actual repetitions in symbols in Slot #1, Slot #2, and Slot #3 are determined for transmission.

### (3) Enhanced PUSCH Repetition Type A

In particular, for enhanced PUSCH repetition Type A, the resource allocation in time domain for enhanced PUSCH repetition Type A is almost the same as PUSCH repetition Type A, excluding that the number of repetitions is counted on the basis of available slots. A slot is determined as unavailable if at least one of the symbols indicated by a time domain resource allocation (TDRA) for a PUSCH in the slot overlaps with the symbol not intended for UL transmissions, and semi-static flexible symbol configured by or tdd-UL-DL-ConfigurationCommon, tdd-UL-DL-ConfigurationDedicated, is considered as available.

FIG. 1D illustrates an example for a PUSCH transmission with enhanced PUSCH repetition Type A according to some embodiments of the present disclosure. The embodiments of FIG. 1D assume that K₂=1, S=2, L=8, K=4. Then, the time domain resources for PUSCH with enhanced PUSCH repetition Type A are shown in FIG. 1D. Each of six slots in FIG. 1B, i.e., Slot #0 to Slot #5, includes 14 symbols. As shown in FIG. 1D, each slot is divided into seven parts, and each part includes two symbols for illustrative purpose. In the embodiments of FIG. 1D, a PDCCH transmission is transmitted in Slot #0. Since S=2, each PUSCH transmission is transmitted from a start of the third symbol in a slot. Since K₂=1, the first PUSCH transmission in time domain is transmitted in Slot #1. Since K=4 and since the first to fourth symbols in Slot #2 are configured with a DL transmission direction, four PUSCH transmissions are transmitted in Slot #1, Slot #3, Slot #4, and Slot #5, respectively. That is, no PUSCH transmission is transmitted in Slot #2. Since L=8, each PUSCH transmission transmitted in Slot #1, Slot #3, Slot #4, and Slot #5 include 8 symbols.

### (4) TBOMS

In particular, for a TBOMS, the time domain resource determination can be performed via PUSCH repetition Type A, like TDRA. The number of slots K allocated for TBOMS is determined by using a row index of a TDRA list, configured via radio resource control (RRC) and is counted based on the available slots for UL transmission. The transmission in each slot could be named as one transmission part of the TB in some cases. The determination of available slots is the same as defined in enhanced PUSCH repetition Type A.

FIG. 1E illustrates an example for a PUSCH transmission with TBOMS according to some embodiments of the present disclosure. The embodiments of FIG. 1E assume that K₂=1, S=2, L=8, K=4. Then, the time domain resource for PUSCH with TBOMS could be seen in FIG. 1E. Each of six slots, i.e., Slot #0 to Slot #6, in FIG. 1E includes 14 symbols. As shown in FIG. 1E, each slot is divided into seven parts, and each part includes two symbols for illustrative purpose. In the embodiments of FIG. 1E, a PDCCH transmission is transmitted in Slot #0. Since S=2, each part of one PUSCH transmission is transmitted from a start of the third symbol in a slot. Since K₂=1, the first part of the PUSCH transmission in time domain is transmitted in Slot #1. Since K=4 and since the first to fourth symbols in Slot #2 are configured with a DL transmission direction, four parts of the PUSCH transmissions are transmitted in Slot #1, Slot #3, Slot #4, and Slot #5, respectively. That is, no part of the PUSCH transmission is transmitted in Slot #2. Since L=8, each part of the PUSCH transmission transmitted in Slot #1, Slot #3, Slot #4, and Slot #5 include 8 symbols.

Regarding a resource allocation in time domain, for CG Type 1 PUSCH transmissions, the higher layer parameter timeDomainAllocation value m provides a row index m+1 pointing to the determined time domain resource allocation table, where the start symbol and length are determined following the procedure defined in above for dynamically scheduled PUSCH. Regarding a resource allocation in time domain, for CG Type 2 PUSCH transmissions, the resource allocation follows UL grant received on the DCI.

There are also four mainly resource allocation schemes in time domain for CG Type 1 PUSCH transmissions or CG Type 2 PUSCH transmission(s), which include: (1) PUSCH repetition Type A; (2) PUSCH repetition Type B; (3) enhanced PUSCH repetition Type A; and (4) TBOMS. These four schemes have some differences from the resource allocation schemes in time domain for dynamically scheduled PUSCH transmission(s) as described above. For example, in resource allocation schemes in time domain for CG Type 1 or Type 2 PUSCH transmissions, for PUSCH repetition Type A, PUSCH repetition Type B, an enhanced PUSCH repetition Type A, and TBOMS, the number of (nominal) repetitions K to be applied to the transmitted transport block is provided by the indexed row in the time domain resource allocation table if memberOfRepetitions is present in the table; otherwise, K is provided by the higher layer configured parameters repK. Besides, other procedures defined in the resource allocation schemes in time domain for dynamically scheduled PUSCH transmission(s) as described above could be reused in the resource allocation schemes in time domain for CG Type 1 or Type 2 PUSCH transmission(s).

In particular, for PUSCH repetition Type B, for CG Type 1 or Type 2 PUSCH transmission(s), nominal repetition(s) and actual repetition(s) are determined according to the procedures for PUSCH repetition Type B defined in the resource allocation schemes in time domain for dynamically scheduled PUSCH transmission(s) as described above.

FIG. 1F illustrates an example for a sub-band full duplex scenario according to some embodiments of the present disclosure. As shown in FIG. 1F, Slot #0 or Slot #1 corresponds to three frequency domain sub-bands and two DL frequency domain sub-bands and one UL frequency domain sub-band. Slot #2 corresponds to all frequency domain sub-bands configured with only uplink transmission direction.

According to the background NR resource allocation schemes as described above, it is observed that a BS could only indicate one frequency domain resource in the BWP. For PUSCH repetition Type A, PUSCH repetition Type B, and enhanced PUSCH repetition Type A, the frequency domain resource of each repetition is the same. For TBOMS, the frequency domain resource of each part of the PUSCH transmission is the same.

As a result, in a sub-band full duplex scenario, the indicated frequency domain resource would cross multiple frequency domain sub-bands configured with different transmission directions in some slots, e.g., PUSCH 1 as shown in FIG. 1G.

FIG. 1G illustrates an example for a frequency domain resource crossing multiple frequency domain sub-bands configured with different transmission directions according to some embodiments of the present disclosure. As shown in FIG. 1G, PUSCH 1 in Slot #0 is crossing multiple frequency domain sub-bands configured with different transmission directions, i.e., PUSCH 1 is crossing two DL sub-bands and one UL sub-band in Slot #0. However, PUSCH 2 in Slot #2 is only in the UL sub-band in Slot #2, but is not crossing multiple frequency domain sub-bands configured with different transmission directions.

The situation in the embodiments of FIG. 1G could be avoided by indicating a small frequency domain resource by a BS, which means that a UE does not expect that the indicated frequency domain resource would cross multiple frequency domain sub-bands configured with different transmission directions in any slot. For dynamically scheduled PUSCH without repetition, this method would not have any limitation. But for CG PUSCH transmission without repetition or PUSCH with repetition or TBOMS, always indicating a small frequency domain resource is not reasonable considering the scheduling flexibility and resource utilization.

Thus, currently, schemes are needed to solve an issue of how to transmit a PUSCH transmission if the indicated frequency domain resource of the PUSCH transmission would cross multiple frequency domain sub-bands configured with different transmission directions in sub-band full duplex scenario.

Embodiments of the present application aim to solve the above-mentioned issue, i.e., how to transmit PUSCH in a case that the indicated frequency domain resource of PUSCH would cross multiple frequency domain sub-bands configured with different transmission directions in sub-band full duplex scenario. Specifically, some embodiments of the present application assume that a BS configures different transmission directions for sub-bands in some slots by higher layer signaling or dynamic signaling, so, a UE knows whether a slot is configured with sub-band full duplex or not and the transmission direction of each sub-band.

Some embodiments of the present application provide Solution 1. In Solution 1, a PUSCH transmission which crosses multiple frequency domain sub-bands configured with different transmission directions is omitted. Specific examples of Solution 1 are described in embodiments of FIGS. 7-10 as follows.

Some further embodiments of the present application provide Solution 2. In Solution 2, two frequency domain resources are indicated and one within these two frequency domain resources is used in different time units (e.g., slots). Specific examples of Solution 2 are described in embodiments of FIGS. 11-19 as follows.

Some other embodiments of the present application provide Solution 3. In Solution 3, one frequency domain resource is indicated, and this frequency domain resource is adjusted by a UE to adapt the frequency domain sub-band configuration according to predefined rules. Solution 3 introduces embodiments for CG PUSCH transmission(s) without repetition. In particular, embodiments for PUSCH repetition Type A or Type B or enhanced PUSCH repetition Type A, or TBOMS are similar to the embodiments of Solution 2. Different from Solution 2, two resources used for transmission in Solution 3 include one resource indicated by a BS and the other resource re-interpreted by a UE according to the indicated resource. Specific examples of Solution 3 are described in embodiments of FIGS. 20 and 21 as follows. More details will be illustrated in following text in combination with the appended drawings.

FIG. 2 illustrates an exemplary block diagram of an apparatus according to some embodiments of the present application. As shown in FIG. 2, the apparatus 200 may include at least one processor 204 and at least one transceiver 202 coupled to the processor 204. The at least one transceiver 202 may be a wired transceiver or a wireless transceiver. The apparatus 200 may be a UE or a network node (e.g., a BS).

Although in this figure, elements such as the at least one transceiver 202 and the processor 204 are described in the singular, the plural is contemplated unless a limitation to the singular is explicitly stated. In some embodiments of the present application, the transceiver 202 may be divided into two devices, such as a receiving circuitry and a transmitting circuitry. In some embodiments of the present application, the apparatus 200 may further include an input device, a memory, and/or other components.

In some embodiments of the present application, the apparatus 200 may be a UE (e.g., UE 101a or UE 101b as shown and illustrated in FIG. 1A). Such embodiments correspond to Solution 2 and Solution 3. In particular, the processor 204 of the UE may be configured: to receive, via the transceiver 202 from a network node (e.g., BS 102a or BS 102b as shown and illustrated in FIG. 1A), at least one indication indicating at least one frequency domain transmission resource; and to determine a frequency domain resource in a time unit according to a type of the time unit. In following text, the frequency domain resource is named as “the 1st frequency domain resource”, and the time unit is named as “the 1st time unit” for simplicity.

The 1st time unit may comprise at least one of: a slot, a symbol, a frame, a sub-frame, a sub-slot, or a mini-slot. The 1st frequency domain resource is used for transmitting a 1st PUSCH transmission. The 1st frequency domain resource is associated with the at least one frequency domain transmission resource.

According to some embodiments, the 1st PUSCH transmission may carry: (1) a repetition of a PUSCH transmission with PUSCH repetition Type A; or (2) a repetition of a PUSCH transmission with enhanced PUSCH repetition Type A; or (3) a nominal repetition of a PUSCH transmission with PUSCH repetition Type B; or (4) an actual repetition of a PUSCH transmission with PUSCH repetition Type B; or (5) a transmission part of a PUSCH transmission with TBOMS.

According to some embodiments, the type of the 1st time unit may comprise a time unit type (which may be named as “the 1st time unit type”) or a further time unit type (which may be named as “the 2nd time unit type”). A time unit having the 1st time unit type means that the time unit corresponds to all frequency domain sub-bands configured with only one transmission direction. The only one transmission direction may be: a downlink transmission direction, an uplink transmission direction, or a flexible transmission direction. A time unit having the 2nd time unit type means that the time unit corresponds to at least two frequency domain sub-bands configured with different transmission directions. Each transmission direction within the different transmission directions may be: the downlink transmission direction, the uplink transmission direction, or the flexible transmission direction.

According to some embodiments, the processor 204 of the UE is configured to receive an indication indicating a type of at least one time unit. The at least one time unit comprises the 1st time unit. This indication may be named as “the 1st indication” in following text. In some embodiments, the 1st indication may be carried in higher layer signaling (e.g., RRC signaling) from the network node or in downlink control information from the network node.

In some embodiments, in a case that the at least one indication includes one indication, the one indication may be used to indicate a 1st frequency domain transmission resource and a 2nd frequency domain transmission resource. In some other embodiments, in a case that the at least one indication includes a 2nd indication and a 3rd indication, the 2nd indication is used to indicate the 1st frequency domain transmission resource, and the 3rd indication is used to indicate the 2nd frequency domain transmission resource. For instance, the 1st frequency domain transmission resource is associated with the 1st time unit type; and the 2nd frequency domain transmission resource is associated with the 2nd time unit type. In an embodiment, in a case that the type of the 1st time unit is the 1st time unit type, the 1st frequency domain resource is determined as the 1st frequency domain transmission resource. In a further embodiment, in a case that the type of the 1st time unit is the 2nd time unit type, the 1st frequency domain resource is determined as the 2nd frequency domain transmission resource.

According to some embodiments, in a case that the at least one indication includes one indication, the one indication is used to indicate one frequency domain transmission resource. In some embodiments, in a case that the type of the 1st time unit is the 1st time unit type, the 1st frequency domain resource is determined as the one frequency domain transmission resource. In some further embodiments, in a case that the type of the 1st time unit is the 2nd time unit type, the 1st frequency domain resource is determined as the one frequency domain transmission resource removed at least one RB crossing multiple frequency sub-bands configured with different transmission directions. A specific example is described in the embodiments of FIG. 20 as follows.

In some other embodiments, the processor 204 of the UE may be configured to interpret the one indication based on a RB indexing, wherein the 1st frequency domain resource is determined as the one frequency domain transmission resource. In an embodiment, in a case that the type of the 1st time unit is the 1st time unit type, the RB indexing is determined within a frequency sub-band configured with an uplink transmission direction. In a further embodiment, in a case that the type of the 1st time unit is the 2nd time unit type, the RB indexing is determined within a bandwidth part (BWP). A specific example is described in some embodiments of FIG. 21 as follows.

In some additional embodiments, the processor 204 of the UE may be configured: to interpret the one indication based on a RB indexing, wherein the RB indexing is determined within a BWP; and after interpreting the one indication, in response to the type of the 1st time unit being the 1st time unit type and in response to the one frequency domain transmission resource including the RB crossing the boundary of the at least two sub-bands configured with different transmission directions, to re-determine the RB indexing within an frequency sub-band configured with an uplink transmission direction and to determine the one frequency domain transmission resource as the 1st frequency domain transmission resource. A specific example is described in some other embodiments of FIG. 21 as follows.

According to some embodiments, the processor 204 of the UE may be configured: in response to the type of the 1st time unit being the 1st time unit type, to determine a 2nd frequency domain resource in a 2nd time unit. The 2nd time unit comprises at least one of: a slot, a symbol, a frame, a sub-frame, a sub-slot, or a mini-slot. The 2nd frequency domain resource is used for transmitting a 2nd PUSCH transmission. The 2nd frequency domain resource and the 1st frequency domain resource are the same.

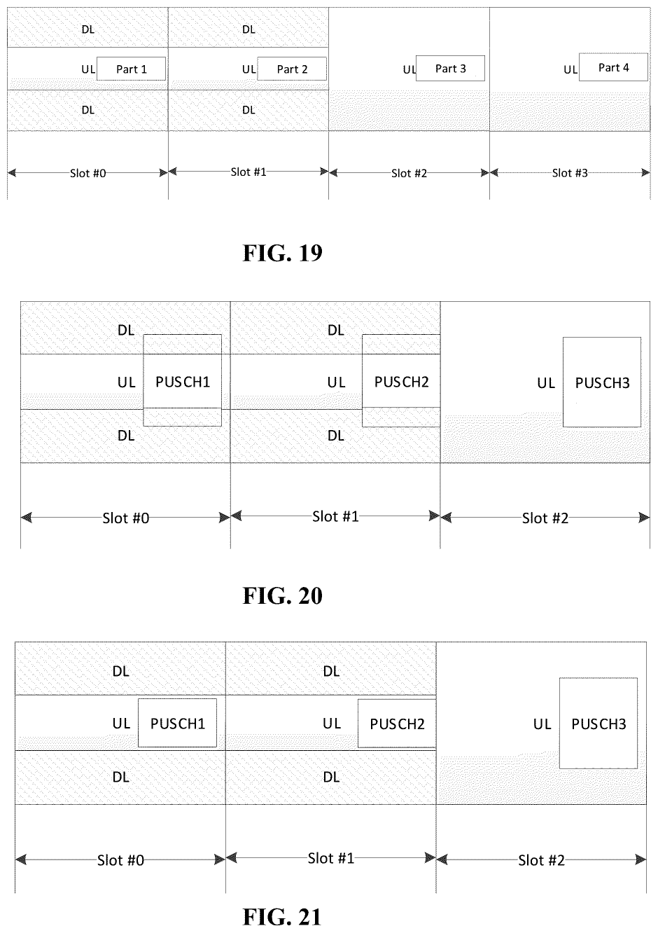

In some embodiments, the 1st PUSCH transmission and the 2nd PUSCH transmission carry: (1) two separate repetitions of a PUSCH transmission with PUSCH repetition Type A; or (2) two separate repetitions of a PUSCH transmission with enhanced PUSCH repetition Type A; or (3) two separate nominal repetitions of a PUSCH transmission with PUSCH repetition Type B; or (4) two separate actual repetitions of a PUSCH transmission with PUSCH repetition Type B; or (5) two separate transmission parts of a PUSCH transmission with TBOMS. A specific example is described in the embodiments of FIG. 19 as follows.

In some other embodiments, the 2nd PUSCH transmission carries: (1) a repetition of a PUSCH transmission with PUSCH repetition Type A; or (2) a repetition of a PUSCH transmission with enhanced PUSCH repetition Type A; or (3) a nominal repetition of a PUSCH transmission with PUSCH repetition Type B; or (4) an actual repetition of a PUSCH transmission with PUSCH repetition Type B; or (5) a transmission part of a PUSCH transmission with TBOMS. The 1st PUSCH transmission carries: (1) a firstly appeared repetition of the PUSCH transmission with PUSCH repetition Type A in a time domain; or (2) a firstly appeared repetition of the PUSCH transmission with enhanced PUSCH repetition Type A in the time domain; or (3) a firstly appeared nominal repetition of the PUSCH transmission with PUSCH repetition Type B in the time domain; or (4) a firstly appeared actual repetition of the PUSCH transmission with PUSCH repetition Type B in the time domain; or (5) a firstly appeared transmission part of the PUSCH transmission with TBOMS. A specific example is described in the embodiments of FIG. 19 as follows.

According to some embodiments of the present application, the apparatus 200 may be a UE (e.g., UE 101a or UE 101b as shown and illustrated in FIG. 1A). Such embodiments correspond to Solution 1. In particular, the processor 204 of the UE may be configured: to receive, via the transceiver 202 from a network node (e.g., BS 102a or BS 102b as shown and illustrated in FIG. 1A), an indication indicating a frequency domain transmission resource; and to determine whether to transmit a PUSCH transmission on the frequency domain transmission resource or not in a time unit (which may be named as “the 1st time unit”) according to a type of the 1st time unit. The type of the 1st time unit comprises a 1st time unit type or a 2nd time unit type, as described above. The 1st time unit may comprise at least one of: a slot, a symbol, a frame, a sub-frame, a sub-slot, or a mini-slot.

According to some embodiments, the PUSCH transmission may carry: (1) a repetition of a PUSCH transmission with PUSCH repetition Type A; or (2) a repetition of a PUSCH transmission with enhanced PUSCH repetition Type A; or (3) a nominal repetition of a PUSCH transmission with PUSCH repetition Type B; or (4) an actual repetition of a PUSCH transmission with PUSCH repetition Type B; or (5) a transmission part of a PUSCH transmission with TBOMS.

In some embodiments, the processor 204 of the UE may be configured to receive an indication (which may be named as “the 1st indication”) indicating a type of at least one time unit. The at least one time unit comprises the 1st time unit. In some embodiments, the 1st indication may be carried in higher layer signaling (e.g., RRC signaling) from the network node or in downlink control information from the network node.

In some embodiments, the processor 204 of the UE may be configured: in response to the type of the 1st time unit being the 1st time unit type and in response to the frequency domain transmission resource including a RB crossing a boundary of at least two sub-bands with different transmission directions, to determine not to transmit the PUSCH transmission in the 1st time unit.

In some embodiments of the present application, the apparatus 200 may be a network node (e.g., BS 102a or BS 102b as shown and illustrated in FIG. 1A). Such embodiments correspond to Solution 2 and Solution 3. In particular, the processor 204 of the network node may be configured: to transmit, via the transceiver 202 of the network node to a UE (e.g., UE 101a or UE 101b as shown and illustrated in FIG. 1A), at least one indication indicating at least one frequency domain transmission resource; and to determine a frequency domain resource (which may be named as “the 1st frequency domain resource”) in a time unit (which may be named as “the 1st time unit”) according to a type of the 1st time unit. The 1st time unit comprises at least one of: a slot, a symbol, a frame, a sub-frame, a sub-slot, or a mini-slot. The 1st frequency domain resource is used for receiving a PUSCH transmission (which may be named as “the 1st PUSCH transmission”). The 1st frequency domain resource is associated with the at least one frequency domain transmission resource. The type of the 1st time unit comprises a time unit type (which may be named as “the 1st time unit type”) or a further time unit type (which may be named as “the 2nd time unit type”). A time unit having the 1st time unit type means that the time unit corresponds to all frequency domain sub-bands configured with only one transmission direction. The only one transmission direction is: a downlink transmission direction, an uplink transmission direction, or a flexible transmission direction. A time unit having the 2nd time unit type means that the time unit corresponds to at least two frequency domain sub-bands configured with different transmission directions. Each transmission direction within the different transmission directions is: the downlink transmission direction, the uplink transmission direction, or the flexible transmission direction.

According to some embodiments, the 1st PUSCH transmission may carry: (1) a repetition of a PUSCH transmission with PUSCH repetition Type A; or (2) a repetition of a PUSCH transmission with enhanced PUSCH repetition Type A; or (3) a nominal repetition of a PUSCH transmission with PUSCH repetition Type B; or (4) an actual repetition of a PUSCH transmission with PUSCH repetition Type B; or (5) a transmission part of a PUSCH transmission with TBOMS.

According to some embodiments, the processor 204 of the network node may be configured: to transmit an indication (which may be named as “the 1st indication”) indicating a type of at least one time unit, which comprises the 1st time unit. For example, the 1st indication is carried in higher layer signaling (e.g., RRC signaling) or downlink control information.

In some embodiments, in a case that the at least one indication includes one indication, the one indication may be used to indicate a 1st frequency domain transmission resource and a 2nd frequency domain transmission resource. In some other embodiments, in a case that the at least one indication includes a 2nd indication and a 3rd indication, the 2nd indication is used to indicate the 1st frequency domain transmission resource, and the 3rd indication is used to indicate the 2nd frequency domain transmission resource. For instance, the 1st frequency domain transmission resource is associated with the 1st time unit type; and the 2nd frequency domain transmission resource is associated with the 2nd time unit type. In a case that the type of the 1st time unit is the 1st time unit type, the 1st frequency domain resource is determined as the 1st frequency domain transmission resource. In a case that the type of the 1st time unit is the 2nd time unit type, the 1st frequency domain resource is determined as the 2nd frequency domain transmission resource.

According to some embodiments, in a case that the at least one indication includes one indication, the one indication may be used to indicate one frequency domain transmission resource. In a case that the type of the 1st time unit is the 1st time unit type, the 1st frequency domain resource is determined as the one frequency domain transmission resource. In a case that the type of the 1st time unit is the 2nd time unit type, the 1st frequency domain resource is determined as the one frequency domain transmission resource removed at least one RB crossing multiple frequency sub-bands configured with different transmission directions.

According to some embodiments, the processor 204 of the network node may be configured: to interpret the one indication based on a resource block (RB) indexing, wherein the 1st frequency domain resource is determined as the one frequency domain transmission resource. In a case that the type of the 1st time unit is the 1st time unit type, the RB indexing is determined within a frequency sub-band configured with an uplink transmission direction. In a case that the type of the 1st time unit is the 2nd time unit type, the RB indexing is determined within a BWP.

According to some embodiments, the processor 204 of the network node may be configured: to interpret the one indication based on a RB indexing, wherein the RB indexing is determined within a BWP; and after interpreting the one indication, in response to the type of the 1st time unit being the 1st time unit type and in response to the one frequency domain transmission resource including the RB crossing the boundary of the at least two sub-bands configured with different transmission directions, to re-determine the RB indexing within an frequency sub-band configured with an uplink transmission direction and to determine the one frequency domain transmission resource as the 1st frequency domain transmission resource.

According to some embodiments, the processor 204 of the network node may be configured: in response to the type of the 1st time unit being the 1st time unit type, to determine a 2nd frequency domain resource in a 2nd time unit. The 2nd time unit comprises at least one of: a slot, a symbol, a frame, a sub-frame, a sub-slot, or a mini-slot. The 2nd frequency domain resource is used for transmitting a further PUSCH transmission (which may be named as “the 2nd PUSCH transmission”). The 2nd frequency domain resource and the 1st frequency domain resource are the same. In some embodiments, the 1st PUSCH transmission and the 2nd PUSCH transmission carry:
(1) two separate repetitions of a PUSCH transmission with PUSCH repetition Type A; or
(2) two separate repetitions of a PUSCH transmission with enhanced PUSCH repetition Type A; or
(3) two separate nominal repetitions of a PUSCH transmission with PUSCH repetition Type B; or
(4) two separate actual repetitions of a PUSCH transmission with PUSCH repetition Type B; or
(5) two separate transmission parts of a PUSCH transmission with TBOMS.

In some other embodiments, the 2nd PUSCH transmission carries: (1) a repetition of a PUSCH transmission with PUSCH repetition Type A; or (2) a repetition of a PUSCH transmission with enhanced PUSCH repetition Type A; or (3) a nominal repetition of a PUSCH transmission with PUSCH repetition Type B; or (4) an actual repetition of a PUSCH transmission with PUSCH repetition Type B; or (5) a transmission part of a PUSCH transmission with TBOMS. The 1st PUSCH transmission carries: (1) a firstly appeared repetition of the PUSCH transmission with PUSCH repetition Type A in a time domain; or (2) a firstly appeared repetition of the PUSCH transmission with enhanced PUSCH repetition Type A in the time domain; or (3) a firstly appeared nominal repetition of the PUSCH transmission with PUSCH repetition Type B in the time domain; or (4) a firstly appeared actual repetition of the PUSCH transmission with PUSCH repetition Type B in the time domain; or (5) a firstly appeared transmission part of the PUSCH transmission with TBOMS.

In some embodiments of the present application, the apparatus 200 may be a network node (e.g., BS 102a or BS 102b as shown and illustrated in FIG. 1A). Such embodiments correspond to Solution 1. In particular, the processor 204 of the network node may be configured: to transmit, via the transceiver 202 of the network node to a UE (e.g., UE 101a or UE 101b as shown and illustrated in FIG. 1A), an indication indicating a frequency domain transmission resource; and to determine whether to receive a PUSCH transmission on the frequency domain transmission resource or not in a time unit (which may be named as “the 1st time unit”) according to a type of the 1st time unit. The 1st time unit may comprise at least one of: a slot, a symbol, a frame, a sub-frame, a sub-slot, or a mini-slot. The type of the 1st time unit comprises a 1st time unit type or a 2nd time unit type, as described above.

According to some embodiments, the PUSCH transmission may carry: (1) a repetition of a PUSCH transmission with PUSCH repetition Type A; or (2) a repetition of a PUSCH transmission with enhanced PUSCH repetition Type A; or (3) a nominal repetition of a PUSCH transmission with PUSCH repetition Type B; or (4) an actual repetition of a PUSCH transmission with PUSCH repetition Type B; or (5) a transmission part of a PUSCH transmission with TBOMS.

In some embodiments, the processor 204 of the network node may be configured: to transmit an indication (which may be named as “the 1st indication”) indicating a type of at least one time unit, which comprises the 1st time unit. For example, the 1st indication is carried in higher layer signaling (e.g., RRC signaling) or downlink control information.

In some embodiments, the processor 204 of the network node may be configured: in response to the type of the 1st time unit being the 1st time unit type and in response to the frequency domain transmission resource including a RB crossing a boundary of at least two sub-bands with different transmission directions, to determine not to receive the PUSCH transmission in the 1st time unit.

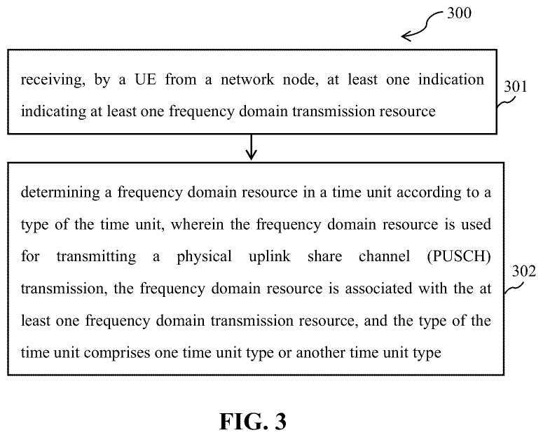

In some embodiments of the present application, the apparatus 200 may include at least one non-transitory computer-readable medium. In some embodiments of the present disclosure, the non-transitory computer-readable medium may have stored thereon computer-executable instructions to cause a processor to implement the method with respect to a UE or a network node (e.g., a BS) as described above. For example, the computer-executable instructions, when executed, cause the processor 204 interacting with the transceiver 202, so as to perform operations of the methods, e.g., as described in view of FIGS. 3-6.

FIG. 3 illustrates an exemplary flow chart of a method for receiving an indication indicating a frequency domain transmission resource according to some embodiments of the present application. The method 300 may be performed by a UE (e.g., UE 101a or UE 101b as shown and illustrated in FIG. 1A). Although described with respect to a UE, it should be understood that other devices may also be configured to perform the method as shown and illustrated in FIG. 3. The embodiments of FIG. 3 correspond to Solution 2 and Solution 3.

In the exemplary method 300 as shown in FIG. 3, in operation 301, a UE (e.g., UE 101a or UE 101b as shown and illustrated in FIG. 1A) receives, from a network node (e.g., BS 102a or BS 102b as shown and illustrated in FIG. 1A), at least one indication indicating at least one frequency domain transmission resource.

In operation 302, the UE determines a frequency domain resource (which may be named as “the 1st frequency domain resource”) in a time unit (which may be named as “the 1st time unit”) according to a type of the 1st time unit. The 1st time unit may comprise at least one of: a slot, a symbol, a frame, a sub-frame, a sub-slot, or a mini-slot. The 1st frequency domain resource is used for transmitting a PUSCH transmission (which may be named as “the 1st PUSCH transmission”). The 1st frequency domain resource is associated with the at least one frequency domain transmission resource.

According to some embodiments, the 1st PUSCH transmission may carry: (1) a repetition of a PUSCH transmission with PUSCH repetition Type A; or (2) a repetition of a PUSCH transmission with enhanced PUSCH repetition Type A; or (3) a nominal repetition of a PUSCH transmission with PUSCH repetition Type B; or (4) an actual repetition of a PUSCH transmission with PUSCH repetition Type B; or (5) a transmission part of a PUSCH transmission with TBOMS.

The type of the 1st time unit comprises a time unit type (which may be named as “the 1st time unit type”) or a further time unit type (which may be named as “the 2nd time unit type”). For example, a time unit having the 1st time unit type means that the time unit corresponds to all frequency domain sub-bands configured with only one transmission direction. The only one transmission direction is: a downlink transmission direction, an uplink transmission direction, or a flexible transmission direction. For example, a time unit having the 2nd time unit type means that the time unit corresponds to at least two frequency domain sub-bands configured with different transmission directions. Each transmission direction within the different transmission directions is: the downlink transmission direction, the uplink transmission direction, or the flexible transmission direction.

It is contemplated that the method illustrated in FIG. 3 may include other operation(s) not shown, for example, any operation(s) described with respect to FIGS. 2, and 4-6. For example, according to some embodiments, the UE further receives an indication (which may be named as “the 1st indication”) indicating a type of at least one time unit, which comprises the 1st time unit. The 1st indication may be carried in higher layer signaling (e.g., RRC signaling) from the network node or in downlink control information from the network node.

According to some embodiments, in a case that the at least one indication including one indication, the one indication is used to indicate a frequency domain transmission resource (which may be named as “the 1st frequency domain transmission resource”) and a further frequency domain transmission resource (which may be named as “the 2nd frequency domain transmission resource”). In a case that the at least one indication including a further indication (which may be named as “the 2nd indication”) and an additional indication (which may be named as “the 3rd indication”), the 2nd indication is used to indicate the frequency domain transmission resource, and the 3rd indication is used to indicate the further frequency domain transmission resource. For example, the 1st frequency domain transmission resource is associated with the 1st time unit type. The 2nd frequency domain transmission resource is associated with the 2nd time unit type.

In some embodiments, in a case that the type of the 1st time unit is the 1st time unit type, the 1st frequency domain resource is determined as the 1st frequency domain transmission resource. In a case that the type of the 1st time unit is the 2nd time unit type, the 1st frequency domain resource is determined as the 2nd frequency domain transmission resource.

According to some embodiments, in a case that the at least one indication includes one indication, the one indication is used to indicate one frequency domain transmission resource. In some embodiments, in a case that the type of the 1st time unit is the 1st time unit type, the 1st frequency domain resource is determined as the one frequency domain transmission resource. In some further embodiments, in a case that the type of the 1st time unit is the 2nd time unit type, the 1st frequency domain resource is determined as the one frequency domain transmission resource removed at least one RB crossing multiple frequency sub-bands configured with different transmission directions.

In some other embodiments, the UE may interpret the one indication based on a RB indexing, and the 1st frequency domain resource is determined as the one frequency domain transmission resource. In an embodiment, in a case that the type of the 1st time unit is the 1st time unit type, the RB indexing is determined within a frequency sub-band configured with an uplink transmission direction. In a further embodiment, in a case that the type of the 1st time unit is the 2nd time unit type, the RB indexing is determined within a BWP.

In some additional embodiments, the UE may interpret the one indication based on a RB indexing, wherein the RB indexing is determined within a BWP. After interpreting the one indication, in response to the type of the 1st time unit being the 1st time unit type and in response to the one frequency domain transmission resource including the RB crossing the boundary of the at least two sub-bands configured with different transmission directions, the UE may re-determine the RB indexing within an frequency sub-band configured with an uplink transmission direction and may determine the one frequency domain transmission resource as the 1 st frequency domain transmission resource.

According to some embodiments, in response to the type of the 1st time unit being the 1st time unit type, the UE may determine a 2nd frequency domain resource in a 2nd time unit. The 2nd time unit comprises at least one of: a slot, a symbol, a frame, a sub-frame, a sub-slot, or a mini-slot. The 2nd frequency domain resource is used for transmitting a 2nd PUSCH transmission. The 2nd frequency domain resource and the 1st frequency domain resource are the same. In some embodiments, the 1st PUSCH transmission and the 2nd PUSCH transmission carry:
(1) two separate repetitions of a PUSCH transmission with PUSCH repetition Type A; or
(2) two separate repetitions of a PUSCH transmission with enhanced PUSCH repetition Type A; or
(3) two separate nominal repetitions of a PUSCH transmission with PUSCH repetition Type B; or
(4) two separate actual repetitions of a PUSCH transmission with PUSCH repetition Type B; or
(5) two separate transmission parts of a PUSCH transmission with TBOMS.

In some other embodiments, the 2nd PUSCH transmission carries: (1) a repetition of a PUSCH transmission with PUSCH repetition Type A; or (2) a repetition of a PUSCH transmission with enhanced PUSCH repetition Type A; or (3) a nominal repetition of a PUSCH transmission with PUSCH repetition Type B; or (4) an actual repetition of a PUSCH transmission with PUSCH repetition Type B; or (5) a transmission part of a PUSCH transmission with TBOMS. The 1st PUSCH transmission carries: (1) a firstly appeared repetition of the PUSCH transmission with PUSCH repetition Type A in a time domain; or (2) a firstly appeared repetition of the PUSCH transmission with enhanced PUSCH repetition Type A in the time domain; or (3) a firstly appeared nominal repetition of the PUSCH transmission with PUSCH repetition Type B in the time domain; or (4) a firstly appeared actual repetition of the PUSCH transmission with PUSCH repetition Type B in the time domain; or (5) a firstly appeared transmission part of the PUSCH transmission with TBOMS.

Details described in all other embodiments of the present application (for example, details regarding a resource allocation scheme in a sub-band full duplex scenario) are applicable for the embodiments of FIG. 3. Moreover, details described in the embodiments of FIG. 3 are applicable for all embodiments of FIGS. 1, 2, and 4-27. It should be appreciated by persons skilled in the art that the sequence of the operations in exemplary procedure in the embodiments of FIG. 3 may be changed and some of the operations in exemplary procedure in the embodiments of FIG. 3 may be eliminated or modified, without departing from the spirit and scope of the disclosure.

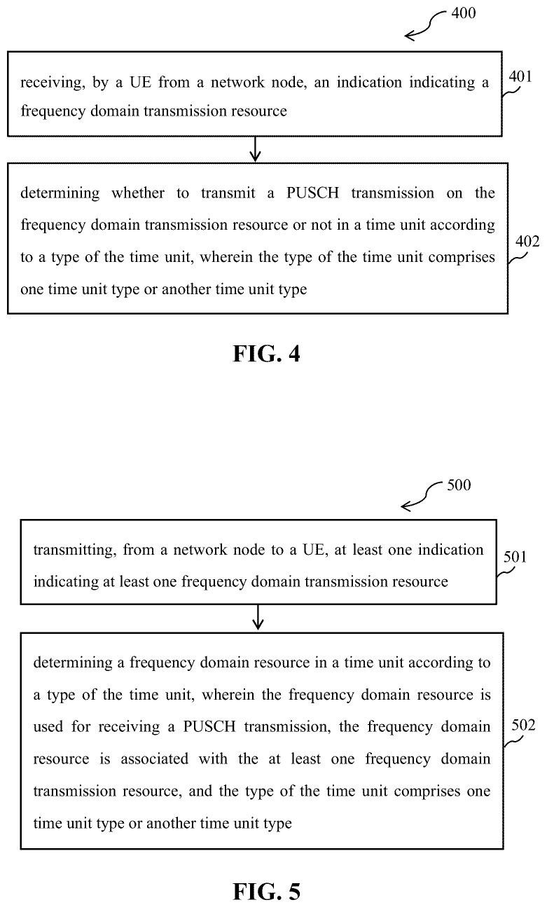

FIG. 4 illustrates a further exemplary flow chart of a method for receiving an indication indicating a frequency domain transmission resource according to some embodiments of the present application. The method 400 may be performed by a UE (e.g., UE 101a or UE 101b as shown and illustrated in FIG. 1A). Although described with respect to a UE, it should be understood that other devices may also be configured to perform the method as shown and illustrated in FIG. 4. The embodiments of FIG. 4 correspond to Solution 1.

In the exemplary method 300 as shown in FIG. 4, in operation 401, a UE (e.g., UE 101a or UE 101b as shown and illustrated in FIG. 1A) receives, from a network node (e.g., BS 102a or BS 102b as shown and illustrated in FIG. 1A), an indication indicating a frequency domain transmission resource. In operation 402, the UE determines whether to transmit a PUSCH transmission on the frequency domain transmission resource or not in a 1st time unit according to a type of the 1st time unit. The 1st time unit may comprise at least one of: a slot, a symbol, a frame, a sub-frame, a sub-slot, or a mini-slot. The type of the 1st time unit comprises a 1st time unit type or a 2nd time unit type, as described above.

According to some embodiments, the PUSCH transmission may carry: (1) a repetition of a PUSCH transmission with PUSCH repetition Type A; or (2) a repetition of a PUSCH transmission with enhanced PUSCH repetition Type A; or (3) a nominal repetition of a PUSCH transmission with PUSCH repetition Type B; or (4) an actual repetition of a PUSCH transmission with PUSCH repetition Type B; or (5) a transmission part of a PUSCH transmission with TBOMS.

It is contemplated that the method illustrated in FIG. 4 may include other operation(s) not shown, for example, any operation(s) described with respect to FIGS. 2, 3, 5, and 6. According to some embodiments, the UE receives a 1st indication indicating a type of at least one time unit, which comprises the 1st time unit. In some embodiments, the 1st indication may be carried in higher layer signaling (e.g., RRC signaling) from the network node or in downlink control information from the network node.

In some embodiments, in response to the type of the 1st time unit being the 1st time unit type and in response to the frequency domain transmission resource including a RB crossing a boundary of at least two sub-bands with different transmission directions, the UE determines not to transmit the PUSCH transmission in the 1st time unit.

Details described in all other embodiments of the present application (for example, details regarding a resource allocation scheme in a sub-band full duplex scenario) are applicable for the embodiments of FIG. 4. Moreover, details described in the embodiments of FIG. 4 are applicable for all embodiments of FIGS. 1-3 and 5-27. It should be appreciated by persons skilled in the art that the sequence of the operations in exemplary procedure in the embodiments of FIG. 4 may be changed and some of the operations in exemplary procedure in the embodiments of FIG. 4 may be eliminated or modified, without departing from the spirit and scope of the disclosure.

FIG. 5 illustrates an exemplary flow chart of a method for transmitting an indication indicating a frequency domain transmission resource according to some embodiments of the present application. The embodiments of FIG. 5 may be performed by a network node (e.g., BS 102a or BS 102b as shown and illustrated in FIG. 1A). Although described with respect to a network node, it should be understood that other devices may be configured to perform a method similar to that of FIG. 5. The embodiments of FIG. 5 correspond to Solution 2 and Solution 3.

In the exemplary method 500 as shown in FIG. 5, in operation 501, a network node (e.g., BS 102a or BS 102b as shown and illustrated in FIG. 1A) transmits, to a UE (e.g., UE 101a or UE 101b as shown and illustrated in FIG. 1A), at least one indication indicating at least one frequency domain transmission resource.

In operation 502 as shown in FIG. 5, the network node determines a 1st frequency domain resource in a 1st time unit according to a type of the 1st time unit. The 1st frequency domain resource is used for receiving a 1st PUSCH transmission. The 1st frequency domain resource is associated with the at least one frequency domain transmission resource. The type of the 1st time unit comprises a 1st time unit type or a 2nd time unit type. The 1st time unit comprises at least one of: a slot, a symbol, a frame, a sub-frame, a sub-slot, or a mini-slot. The 1st frequency domain resource is used for receiving a PUSCH transmission (which may be named as “the 1st PUSCH transmission”). The 1st frequency domain resource is associated with the at least one frequency domain transmission resource. The type of the 1st time unit comprises a time unit type (which may be named as “the 1st time unit type”) or a further time unit type (which may be named as “the 2nd time unit type”). A time unit having the 1st time unit type means that the time unit corresponds to all frequency domain sub-bands configured with only one transmission direction. The only one transmission direction is: a downlink transmission direction, an uplink transmission direction, or a flexible transmission direction. A time unit having the 2nd time unit type means that the time unit corresponds to at least two frequency domain sub-bands configured with different transmission directions. Each transmission direction within the different transmission directions is: the downlink transmission direction, the uplink transmission direction, or the flexible transmission direction.

According to some embodiments, the 1st PUSCH transmission may carry: (1) a repetition of a PUSCH transmission with PUSCH repetition Type A; or (2) a repetition of a PUSCH transmission with enhanced PUSCH repetition Type A; or (3) a nominal repetition of a PUSCH transmission with PUSCH repetition Type B; or (4) an actual repetition of a PUSCH transmission with PUSCH repetition Type B; or (5) a transmission part of a PUSCH transmission with TBOMS.

According to some embodiments, the network node may transmit an indication (which may be named as “the 1st indication”) indicating a type of at least one time unit, which comprises the 1st time unit. For example, the 1st indication is carried in higher layer signaling (e.g., RRC signaling) or downlink control information.

In some embodiments, in a case that the at least one indication includes one indication, the one indication is used to indicate a 1st frequency domain transmission resource and a 2nd frequency domain transmission resource. In some other embodiments, in a case that the at least one indication includes a 2nd indication and a 3rd indication, the 2nd indication is used to indicate the 1st frequency domain transmission resource, and the 3rd indication is used to indicate the 2nd frequency domain transmission resource. For instance, the 1st frequency domain transmission resource is associated with the 1st time unit type; and the 2nd frequency domain transmission resource is associated with the 2nd time unit type. In a case that the type of the 1st time unit is the 1st time unit type, the 1st frequency domain resource is determined as the 1st frequency domain transmission resource. In a case that the type of the 1st time unit is the 2nd time unit type, the 1st frequency domain resource is determined as the 2nd frequency domain transmission resource.

According to some embodiments, in a case that the at least one indication includes one indication, the one indication is used to indicate one frequency domain transmission resource. In a case that the type of the 1st time unit is the 1st time unit type, the 1st frequency domain resource is determined as the one frequency domain transmission resource. In a case that the type of the 1st time unit is the 2nd time unit type, the 1st frequency domain resource is determined as the one frequency domain transmission resource removed at least one RB crossing multiple frequency sub-bands configured with different transmission directions.

According to some embodiments, the network node may interpret the one indication based on a RB indexing, wherein the 1st frequency domain resource is determined as the one frequency domain transmission resource. In a case that the type of the 1st time unit is the 1st time unit type, the RB indexing is determined within a frequency sub-band configured with an uplink transmission direction. In a case that the type of the 1st time unit is the 2nd time unit type, the RB indexing is determined within a BWP.

According to some embodiments, the network node may interpret the one indication based on a RB indexing, wherein the RB indexing is determined within a BWP. After interpreting the one indication, in response to the type of the 1st time unit being the 1st time unit type and in response to the one frequency domain transmission resource including the RB crossing the boundary of the at least two sub-bands configured with different transmission directions, the network node may re-determine the RB indexing within an frequency sub-band configured with an uplink transmission direction and may determine the one frequency domain transmission resource as the 1st frequency domain transmission resource.

According to some embodiments, in response to the type of the 1st time unit being the 1st time unit type, the network node may determine a 2nd frequency domain resource in a 2nd time unit. The 2nd time unit comprises at least one of: a slot, a symbol, a frame, a sub-frame, a sub-slot, or a mini-slot. The 2nd frequency domain resource is used for transmitting a further PUSCH transmission (which may be named as “the 2nd PUSCH transmission”). The 2nd frequency domain resource and the 1st frequency domain resource are the same. In some embodiments, the 1st PUSCH transmission and the 2nd PUSCH transmission carry:
(1) two separate repetitions of a PUSCH transmission with PUSCH repetition Type A; or
(2) two separate repetitions of a PUSCH transmission with enhanced PUSCH repetition Type A; or
(3) two separate nominal repetitions of a PUSCH transmission with PUSCH repetition Type B; or
(4) two separate actual repetitions of a PUSCH transmission with PUSCH repetition Type B; or
(5) two separate transmission parts of a PUSCH transmission with TBOMS.

In some other embodiments, the 2nd PUSCH transmission carries: (1) a repetition of a PUSCH transmission with PUSCH repetition Type A; or (2) a repetition of a PUSCH transmission with enhanced PUSCH repetition Type A; or (3) a nominal repetition of a PUSCH transmission with PUSCH repetition Type B; or (4) an actual repetition of a PUSCH transmission with PUSCH repetition Type B; or (5) a transmission part of a PUSCH transmission with TBOMS. The 1st PUSCH transmission carries: (1) a firstly appeared repetition of the PUSCH transmission with PUSCH repetition Type A in a time domain; or (2) a firstly appeared repetition of the PUSCH transmission with enhanced PUSCH repetition Type A in the time domain; or (3) a firstly appeared nominal repetition of the PUSCH transmission with PUSCH repetition Type B in the time domain; or (4) a firstly appeared actual repetition of the PUSCH transmission with PUSCH repetition Type B in the time domain; or (5) a firstly appeared transmission part of the PUSCH transmission with TBOMS.

Details described in all other embodiments of the present application (for example, details regarding a resource allocation scheme in a sub-band full duplex scenario) are applicable for the embodiments of FIG. 5. Moreover, details described in the embodiments of FIG. 5 are applicable for all embodiments of FIGS. 1-4 and 6-27. It should be appreciated by persons skilled in the art that the sequence of the operations in exemplary procedure in the embodiments of FIG. 5 may be changed and some of the operations in exemplary procedure in the embodiments of FIG. 5 may be eliminated or modified, without departing from the spirit and scope of the disclosure.

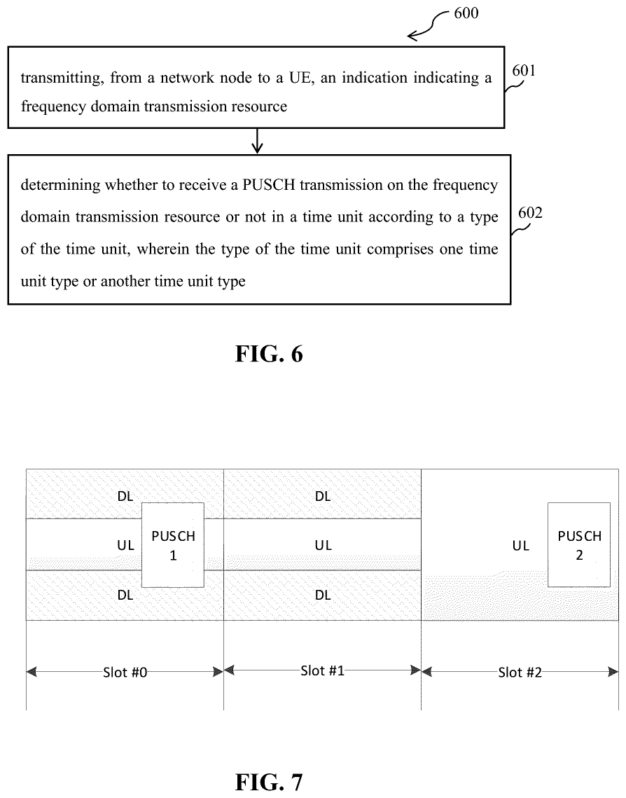

FIG. 6 illustrates a further exemplary flow chart of a method for transmitting an indication indicating a frequency domain transmission resource according to some embodiments of the present application. The embodiments of FIG. 6 may be performed by a network node (e.g., BS 102a or BS 102b as shown and illustrated in FIG. 1A). Although described with respect to a network node, it should be understood that other devices may be configured to perform a method similar to that of FIG. 6. The embodiments of FIG. 6 correspond to Solution 1.

In the exemplary method 600 as shown in FIG. 6, in operation 601, a network node (e.g., BS 102a or BS 102b as shown and illustrated in FIG. 1A) transmits, to a UE (e.g., UE 101a or UE 101b as shown and illustrated in FIG. 1A), an indication indicating a frequency domain transmission resource.

In operation 602 as shown in FIG. 6, the network node determines whether to receive a PUSCH transmission on the frequency domain transmission resource or not in a 1st time unit according to a type of the 1st time unit. The 1st time unit may comprise at least one of: a slot, a symbol, a frame, a sub-frame, a sub-slot, or a mini-slot. The type of the 1st time unit comprises a 1st time unit type or a 2nd time unit type, as described above.

According to some embodiments, the PUSCH transmission may carry: (1) a repetition of a PUSCH transmission with PUSCH repetition Type A; or (2) a repetition of a PUSCH transmission with enhanced PUSCH repetition Type A; or (3) a nominal repetition of a PUSCH transmission with PUSCH repetition Type B; or (4) an actual repetition of a PUSCH transmission with PUSCH repetition Type B; or (5) a transmission part of a PUSCH transmission with TBOMS.

In some embodiments, the network node may transmit an indication (which may be named as “the 1st indication”) indicating a type of at least one time unit, which comprises the 1st time unit. For example, the 1st indication is carried in higher layer signaling (e.g., RRC signaling) or downlink control information.

In some embodiments, in response to the type of the 1st time unit being the 1st time unit type and in response to the frequency domain transmission resource including a RB crossing a boundary of at least two sub-bands with different transmission directions, the network node may determine not to receive the PUSCH transmission in the 1st time unit.

Details described in all other embodiments of the present application (for example, details regarding a resource allocation scheme in a sub-band full duplex scenario) are applicable for the embodiments of FIG. 6. Moreover, details described in the embodiments of FIG. 6 are applicable for all embodiments of FIGS. 1-5 and 7-27. It should be appreciated by persons skilled in the art that the sequence of the operations in exemplary procedure in the embodiments of FIG. 6 may be changed and some of the operations in exemplary procedure in the embodiments of FIG. 6 may be eliminated or modified, without departing from the spirit and scope of the disclosure.

As described above, FIGS. 7-10 refer to embodiments of Solution 1, in which a PUSCH transmission which crosses multiple frequency domain sub-bands configured with different transmission directions is omitted.

FIG. 7 illustrates an exemplary resource allocation scheme for CG PUSCH transmission without repetition according to some embodiments of the present application. In the embodiments of FIG. 7, for CG PUSCH transmission without repetition, in a case that a frequency domain resource of one PUSCH transmission crosses multiple frequency domain sub-bands configured with different transmission directions, the PUSCH transmission is omitted.

For example, as shown in FIG. 7, the frequency domain resource of PUSCH 1 in slot #0 crosses multiple frequency domain sub-bands configured with different transmission directions (i.e., a sub-band configured with DL transmission direction, a sub-band configured with UL transmission direction, and a sub-band configured with DL transmission direction), and thus PUSCH 1 is omitted. As shown in FIG. 7, the frequency domain resource of PUSCH 2 in Slot #2 does not cross multiple frequency domain sub-bands configured with different transmission directions, and thus PUSCH 2 is not omitted, i.e., only PUSCH 2 is transmitted.

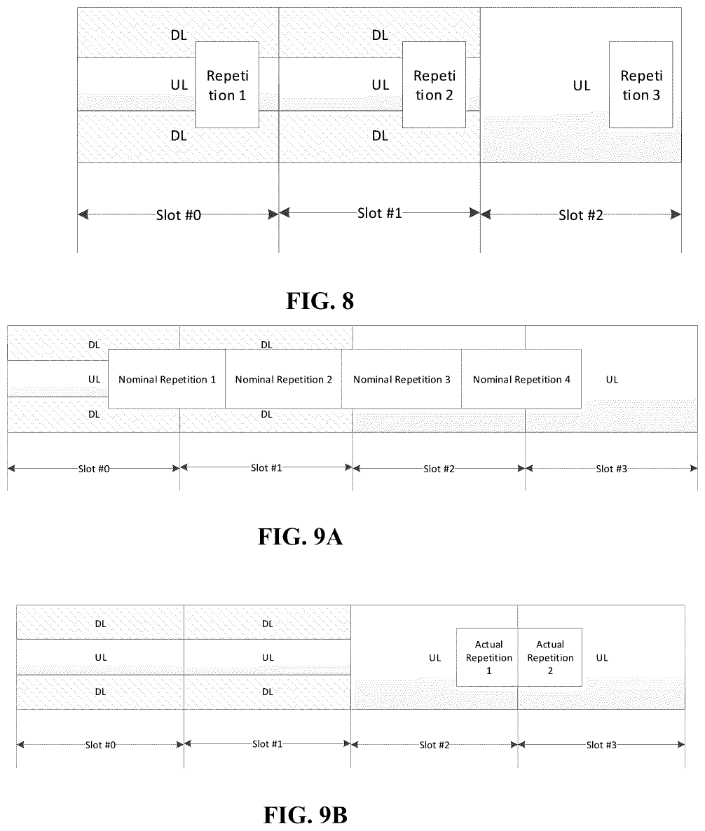

FIG. 8 illustrates an exemplary resource allocation scheme for PUSCH transmission with PUSCH repetition Type A according to some embodiments of the present application. In the embodiments of FIG. 8, for PUSCH transmission with PUSCH repetition Type A, in a case that a frequency domain resource of one PUSCH repetition crosses multiple frequency domain sub-bands configured with different transmission directions, the PUSCH transmission with PUSCH repetition Type A is omitted.

For example, as shown in FIG. 8, the frequency domain resource of PUSCH Repetition 1 in Slot #0 and PUSCH Repetition 2 in Slot #1 cross multiple frequency domain sub-bands configured with different transmission directions, and thus these two repetitions are omitted. As shown in FIG. 8, the frequency domain resource of PUSCH Repetition 3 in Slot #2 does not cross multiple frequency domain sub-bands configured with different transmission directions, and thus this repetition is not omitted, i.e., only PUSCH Repetition 3 is transmitted.

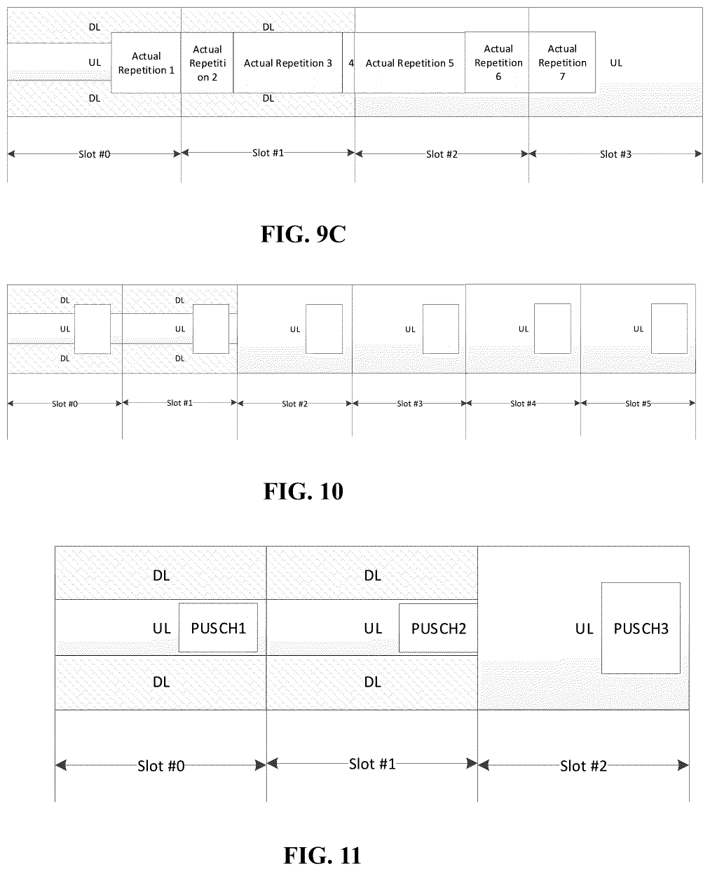

FIGS. 9A, 9B, and 9C illustrate exemplary resource allocation schemes for PUSCH transmission with PUSCH repetition Type B according to some embodiments of the present application. In the embodiments of FIGS. 9A, 9B, and 9C, for PUSCH transmission with PUSCH repetition Type B, in a case that a frequency domain resource of one nominal repetition crosses multiple frequency domain sub-bands configured with different transmission directions, the PUSCH transmission with PUSCH repetition Type B is omitted.

For example, as shown in FIG. 9A, the frequency domain resource of Nominal Repetition 1, Nominal Repetition 2 and Nominal Repetition 3 cross multiple frequency domain sub-bands configured with different transmission directions, and thus these three nominal repetitions are omitted. Nominal Repetition 4 does not cross multiple frequency domain sub-bands configured with different transmission directions, and thus this nominal repetition is not omitted, i.e., only Nominal Repetition 4 is transmitted.

In some embodiments, based on FIG. 9A, the resource for actual repetition could be determined according to current technology, only two actual repetitions could be transmitted as shown in FIG. 9B. In particular, since only Nominal Repetition 4 is transmitted, Nominal Repetition 4 is divided into two actual repetitions according to different slots, i.e., Actual Repetition 1 and Actual Repetition 2 as shown in FIG. 9B. Thus, Actual Repetition 1 is transmitted in Slot #2, and Actual Repetition 2 is transmitted in Slot #3.

Alternatively, in some other embodiments, based on FIG. 9A, for PUSCH transmission with PUSCH repetition Type B, in a case that the frequency domain resource of one actual repetition crosses multiple frequency domain sub-bands configured with different transmission directions, the PUSCH transmission with PUSCH repetition Type B is omitted as shown in FIG. 9C. In the embodiments of FIG. 9C, the resource for actual repetition could be determined according to current technology. Each of Nominal Repetition 1 to Nominal Repetition 4 is divided into two actual repetitions according to different slots. That is, as shown in FIG. 9C, Nominal Repetition 1 is divided into Actual Repetition 1 and Actual Repetition 2, Nominal Repetition 2 corresponds to Actual Repetition 3, Nominal Repetition 3 is divided into Actual Repetition 4 and Actual Repetition 5, and Nominal Repetition 4 is divided into Actual Repetition 6 and Actual Repetition 7. Then, because the frequency domain resource of Actual Repetition 1 to Actual Repetition 4 cross multiple frequency domain sub-bands configured with different transmission directions, these four repetitions are omitted, and only three actual repetitions including Actual Repetition 5, Actual Repetition 6 and Actual Repetition 7 as shown in FIG. 9C could be transmitted.

FIG. 10 illustrates an exemplary resource allocation scheme for PUSCH transmission with enhanced PUSCH repetition Type A and TBOMS according to some embodiments of the present application. In the embodiments of FIG. 10, for PUSCH transmission with enhanced PUSCH repetition Type A and TBOMS, in a case that a frequency domain resource in one slot crosses multiple frequency domain sub-bands configured with different transmission directions, the slot is treated as an unavailable slot.

For example, as shown in FIG. 10, a BS indicates to transmit PUSCH transmission in 4 available slots, i.e., Slot #2, Slot #3, Slot #4, and Slot #5. Because the frequency domain resources in Slot #0 and Slot #1 cross multiple frequency domain sub-bands configured with different transmission directions, these two slots are treated as unavailable slots. Since frequency domain resources in Slot #2, Slot #3, Slot #4, and Slot #5 do not cross multiple frequency domain sub-bands configured with different transmission directions, these four slots are treated as available slots. That is, four slots including Slot #2 to Slot #5 could be used to transmit the PUSCH transmission.

As described above, FIGS. 11-19 refer to embodiments of Solution 2 and solution 3, in which two frequency domain resources are indicated and one within these two frequency domain resources is used in different time units (e.g., slots).

FIG. 11 illustrates an exemplary resource allocation scheme for CG PUSCH transmission without repetition according to some embodiments of the present application.

In the embodiments of FIG. 11, for CG type 1 PUSCH transmission without repetition, two resource assignments applied for the transmission could be provided by higher layer parameter frequencyDomainAllocation and frequencyDomainAllocation-R18 in configuredGrantConfig. For CG type 2 PUSCH transmission without repetition, two resource assignments applied for the transmission could be provided by a resource allocation field in the detected PDCCH DCI and frequency DomainAllocation-R18 in configuredGrantConfig. These two resource assignments could be different and are used to indicate two frequency domain resource used in slot(s) that is configured with sub-band full duplex scheme and normal slot(s) that is not configured with sub-band full duplex scheme, respectively. For example, as shown in FIG. 11, in Slot #0 and Slot #1 configured with sub-band full duplex scheme, one frequency domain resource was used for PUSCH 1 transmission and PUSCH 2 transmission; and in normal Slot #2 that is not configured with sub-band full duplex scheme, the other frequency domain resource is used for PUSCH 3 transmission.

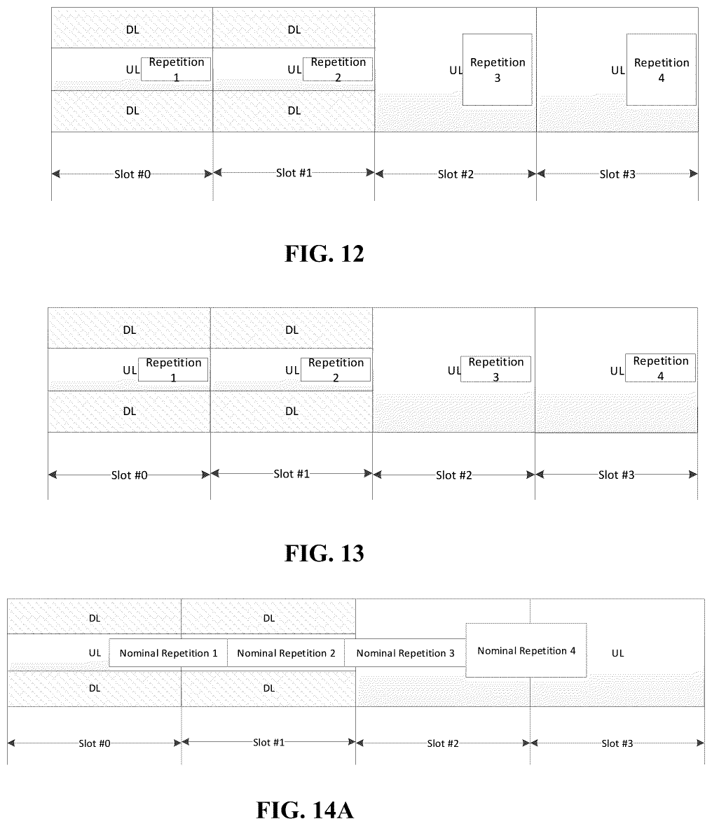

In some embodiments of the present application, for CG type 1 PUSCH transmission with PUSCH repetition Type A or an enhanced PUSCH repetition Type A, two resource assignments applied for the transmission could be provided by higher layer parameter frequencyDomainAllocation and frequencyDomainAllocation-R18 in configuredGrantConfig. For CG type 2 or dynamic scheduled PUSCH transmission with PUSCH repetition Type A or enhanced PUSCH repetition Type A, two resource assignments applied for the transmission could be provided by a resource allocation field in the detected PDCCH DCI and frequencyDomainAllocation-R18 in configuredGrantConfig. These two resource assignments could be different and are used to indicate two frequency domain resource used in slot(s) that is configured with sub-band full duplex scheme and normal slot(s) that is not configured with sub-band full duplex scheme, respectively. Specific examples are described in embodiments of FIGS. 12 and 13 as follows.

FIGS. 12 and 13 illustrates exemplary resource allocation schemes for PUSCH with PUSCH repetition Type A or enhanced PUSCH repetition Type A according to some embodiments of the present application.

In the embodiments of FIG. 12, for each PUSCH repetition, the used frequency domain resource is chosen according to whether the occupied slot of the repetition is configured with sub-band full duplex scheme. For example, as shown in FIG. 12, Slot #0 and Slot #1 are configured with sub-band full duplex scheme, one frequency domain resource was used for PUSCH repetition 1 and PUSCH repetition 2; and in normal Slot #2 and Slot #3 that are not configured with sub-band full duplex scheme, the other frequency domain resource is used for PUSCH repetition 3 and PUSCH repetition 4.

In some embodiments of FIG. 13, in a case that any slot occupied by the PUSCH repetitions is configured with sub-band full duplex scheme, the used frequency domain resource by all the PUSCH repetition is the same and is the smallest frequency domain resource between configured frequency domain resource(s). The smallest frequency domain resource may be a frequency domain resource configured for a slot that is configured with sub-band full duplex scheme. For example, as shown in FIG. 13, because Slot #0 and Slot #1 are configured with sub-band full duplex scheme, all PUSCH repetitions in Slot #0 to Slot #3 use the frequency domain resource configured for the slot (i.e., Slot #0 or Slot #1) configured with sub-band full duplex scheme. In other words, in a case that one slot within all slots is configured with sub-band full duplex scheme, all PUSCH repetitions in this slot and all other slot(s) use the frequency domain resource configured for this slot which is configured with sub-band full duplex scheme.

Alternatively, in some other embodiments of FIG. 13, in a case that a slot occupied by the firstly appeared PUSCH repetitions in time domain is configured with sub-band full duplex scheme, the used frequency domain resource by all the PUSCH repetition is the same and is the smallest frequency domain resource between configured frequency domain resource(s). The smallest frequency domain resource may be a frequency domain resource configured for a slot that is configured with sub-band full duplex scheme. For example, as shown in FIG. 13, because Slot #0 is configured with sub-band full duplex scheme, all PUSCH repetitions in Slot #0 to Slot #3 use the frequency domain resource configured for Slot #0 which is configured with sub-band full duplex scheme.

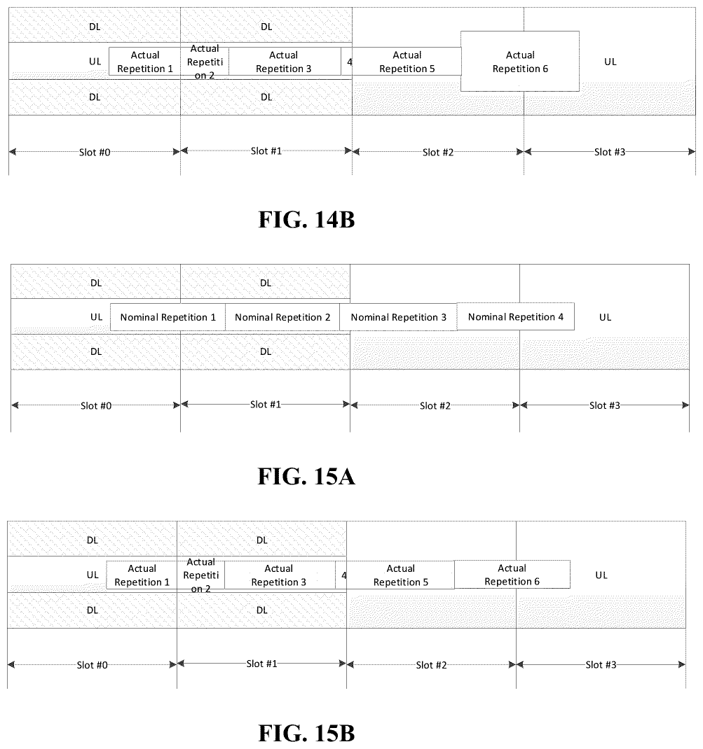

In some embodiments of the present application, for CG type 1 PUSCH transmission with PUSCH repetition Type B, two resource assignments applied for the transmission could be provided by higher layer parameter frequencyDomainAllocation and frequency DomainAllocation-R18 in configuredGrantConfig. For CG type 2 or dynamic scheduled PUSCH transmission with PUSCH repetition Type B, two resource assignments applied for the transmission could be provided by a resource allocation field in the detected PDCCH DCI and frequencyDomainAllocation-R18 in configuredGrantConfig. And these two resource assignments could be different and are used to indicate two frequency domain resource used in slot(s) that is configured with sub-band full duplex scheme and normal slot(s) that is not configured with sub-band full duplex scheme, respectively. Specific examples are described in embodiments of FIGS. 14A, 14B, 15A, and 15B as follows.

FIGS. 14A and 14B illustrate exemplary resource allocation schemes for PUSCH with PUSCH repetition Type B according to some embodiments of the present application.

In the embodiments of FIGS. 14A and 14B, for each nominal PUSCH repetition, the used frequency domain resource is chosen according to whether the occupied slot (which is decided by the starting symbol) of the nominal repetition is configured with sub-band full duplex scheme. For example, as shown in FIG. 14A, the starting symbols of Nominal Repetition 1, Nominal Repetition 2, and Nominal Repetition 3 are in Slot #0 and Slot #1 which are configured with sub-band full duplex scheme. Thus, the smaller frequency domain resource configured for Slot #0 and Slot #1 (which are configured with sub-band full duplex scheme) was used for Nominal Repetition 1, Nominal Repetition 2 and Nominal Repetition 3, while another frequency domain resource configured for Slot #2 is used for Nominal Repetition 4. After that, the resource for actual repetition could be determined according to current technology. For example, the determined actual repetitions of the embodiments of FIG. 14A are shown in FIG. 14B, which include 6 actual repetitions that are decided for PUSCH transmission. That is, as shown in FIG. 14B, Nominal Repetition 1 is divided into Actual Repetition 1 and Actual Repetition 2, Nominal Repetition 2 corresponds to Actual Repetition 3, Nominal Repetition 3 is divided into Actual Repetition 4 and Actual Repetition 5, and Nominal Repetition 4 corresponds to Actual Repetition 6.

FIGS. 15A and 15B illustrate exemplary resource allocation schemes for PUSCH with PUSCH repetition Type B according to some embodiments of the present application.

In some embodiments of FIGS. 15A and 15B, in a case that any slot occupied by the nominal repetitions is configured with sub-band full duplex scheme, the used frequency domain resource by all the nominal repetition is the same and is the smaller frequency domain resource between two frequency domain resources, which is configured for the slot configured with sub-band full duplex scheme. In particular, in these embodiments of FIG. 15A, Slot #0 and Slot #1 are configured with sub-band full duplex scheme. In these embodiments, all nominal repetitions use the frequency domain resource configured for Slot #0 and Slot #1 configured with sub-band full duplex scheme. After that, the resource(s) for actual repetition(s) could be determined according to current technology. For example, the determined actual repetitions of the embodiments of FIG. 15A are shown in FIG. 15B, which include 6 actual repetitions that are decided for PUSCH transmission. As shown in FIG. 15B, Nominal Repetition 1 is divided into Actual Repetition 1 and Actual Repetition 2, Nominal Repetition 2 corresponds to Actual Repetition 3, Nominal Repetition 3 is divided into Actual Repetition 4 and Actual Repetition 5, and Nominal Repetition 4 corresponds to Actual Repetition 6. Therefore, in these embodiments, the frequency domain resources for Actual Repetition 1 to Actual Repetition 6 are the same.

Alternatively, in some other embodiments of FIGS. 15A and 15B, in a case that the slot occupied by the first nominal repetitions in time domain is configured with sub-band full duplex scheme, the used frequency domain resource by all the nominal repetition is the same and is the smaller frequency domain resource between two frequency domain resources, which is configured for the slot configured with sub-band full duplex scheme. In particular, in these embodiments of FIG. 15A, since Slot #0 is configured with sub-band full duplex scheme, the used frequency domain resource by all the nominal repetition is the same as the frequency domain resource configured for Slot #0. As shown in FIG. 15B, Nominal Repetition 1 is divided into Actual Repetition 1 and Actual Repetition 2, Nominal Repetition 2 corresponds to Actual Repetition 3, Nominal Repetition 3 is divided into Actual Repetition 4 and Actual Repetition 5, and Nominal Repetition 4 corresponds to Actual Repetition 6. Therefore, in these embodiments, the frequency domain resources for Actual Repetition 1 to Actual Repetition 6 are the same.

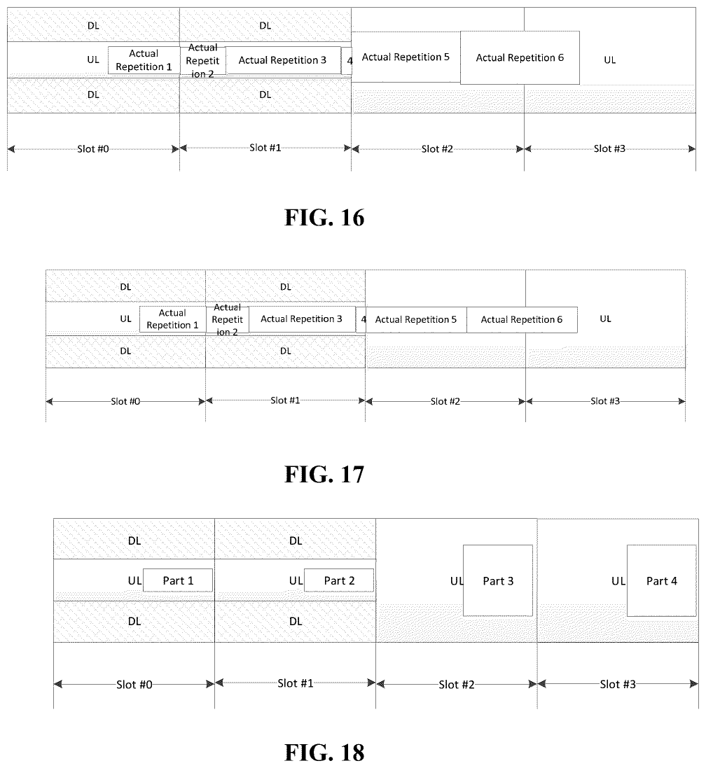

In some embodiments of the present application, for CG type 1 PUSCH transmission with PUSCH repetition Type B, two resource assignments applied for the transmission could be provided by higher layer parameter frequency DomainAllocation and frequency DomainAllocation-R18 in configuredGrantConfig. For CG type 2 or dynamic scheduled PUSCH transmission with PUSCH repetition Type B, two resource assignments applied for the transmission could be provided by a resource allocation field in the detected PDCCH DCI and frequencyDomainAllocation-R18 in configuredGrantConfig. And these two resource assignments could be different and are used to indicate two frequency domain resource used in slot(s) that is configured with sub-band full duplex scheme and normal slot(s) that is not configured with sub-band full duplex scheme, respectively. Specific examples are described in embodiments of FIGS. 16 and 17 as follows.

FIGS. 16 and 17 illustrate exemplary resource allocation schemes for PUSCH with PUSCH repetition Type B according to some embodiments of the present application.

In the embodiments of FIG. 16, for each actual PUSCH repetition, the used frequency domain resource is chosen according to whether the occupied slot of the actual repetition is configured with sub-band full duplex scheme. For example, as shown in FIG. 16, the starting symbols of actual Repetition 1, actual Repetition 2, actual Repetition 3 and actual Repetition 4 are in Slot #0 and Slot #1 which are configured with sub-band full duplex scheme. Thus, the smaller frequency domain resource configured for Slot #0 and Slot #1 (which are configured with sub-band full duplex scheme) was used for actual Repetition 1, actual Repetition 2, actual Repetition 3 and actual Repetition 4, while another frequency domain resource configured for Slot #2 is used for actual Repetition 6.

In some embodiments of FIG. 17, if any slot occupied by the PUSCH repetitions is configured with sub-band full duplex scheme, the used frequency domain resource by all the actual repetition is the same and is the smaller frequency domain resource between two frequency domain resources, which is configured for the slot configured with sub-band full duplex scheme. For example, as shown in FIG. 17, Slot #0 and Slot #1 are configured with sub-band full duplex scheme, and thus all actual repetitions in Slot #0 to Slot #3 (i.e., actual Repetition 1, actual Repetition 2, actual Repetition 3, actual Repetition 4, actual Repetition 5 and actual Repetition 4) use the frequency domain resource configured for Slot #0 and Slot #1 configured with sub-band full duplex scheme.

In some other embodiments of FIG. 17, if the slot occupied by the first repetitions in time domain is configured with sub-band full duplex scheme, the used frequency domain resource by all the actual repetition is the same and is the smaller frequency domain resource between two frequency domain resources, which is configured for the slot configured with sub-band full duplex scheme. For example, as shown in FIG. 17, Slot #0 is configured with sub-band full duplex scheme, all actual repetitions in Slot #0 to Slot #3 (i.e., actual Repetition 1, actual Repetition 2, actual Repetition 3, actual Repetition 4, actual Repetition 5 and actual Repetition 4) use the frequency domain resource configured for Slot #0 and Slot #1 configured with sub-band full duplex scheme.

In some embodiments of the present application, for CG type 1 PUSCH transmission with TBOMS, two resource assignments applied for the transmission could be provided by higher layer parameter frequencyDomainAllocation and frequency DomainAllocation-R18 in configuredGrantConfig. For CG type 2 or dynamic scheduled PUSCH transmission with PUSCH repetition Type A, two resource assignments applied for the transmission could be provided by a resource allocation field in the detected PDCCH DCI and frequencyDomainAllocation-R18 in configuredGrantConfig. And these two resource assignments could be different and are used to indicate two frequency domain resource used in slot(s) that is configured with sub-band full duplex scheme and normal slot(s) that is not configured with sub-band full duplex scheme, respectively. Specific examples are described in embodiments of FIGS. 18 and 19 as follows.

FIGS. 18 and 19 illustrate exemplary resource allocation schemes for PUSCH with TBOMS according to some embodiments of the present application.

In the embodiments of FIG. 18, for each transmission part, the used frequency domain resource is chosen according to whether the occupied slot of transmission part is configured with sub-band full duplex scheme or not. For example, as shown in FIG. 18, in Slot #0 and Slot #1 configured with sub-band full duplex scheme, one frequency domain resource was used for transmission Part 1 and transmission Part 2 of a PUSCH transmission; and in normal Slot #2 and Slot #3 that are not configured with sub-band full duplex scheme, another frequency domain resource is used for transmission Part 3 and transmission Part 4 of the PUSCH transmission. That is, a UE uses one frequency domain resource in Slot #0 and Slot #1, and the UE uses another different frequency domain resource in Slot #2 and Slot #3.

In some embodiments of FIG. 19, if any slot occupied by the transmission part is configured with sub-band full duplex scheme, the used frequency domain resource by all the transmission parts is the same and is the smallest frequency domain resource between configured frequency domain resource(s). The smallest frequency domain resource may be a frequency domain resource configured for a slot that is configured with sub-band full duplex scheme. For example, as shown in FIG. 19, Slot #0 and Slot #1 are configured with sub-band full duplex scheme, and thus all transmission parts (i.e., Part 1 in Slot #0, Part 2 in Slot #1, Part 3 in Slot #2, and Part 4 in Slot #3) use the frequency domain resource configured for Slot #0 and Slot #1 which are configured with sub-band full duplex scheme.

In some other embodiments of FIG. 19, if the slot occupied by the first transmission part in time domain is configured with sub-band full duplex scheme, the used frequency domain resource by all the transmission parts is the same and is a frequency domain resource configured for the slot occupied by the first transmission part in time domain. For example, as shown in FIG. 19, Slot #0 is configured with sub-band full duplex scheme, and thus all transmission parts (i.e., Part 1 in Slot #0, Part 2 in Slot #1, Part 3 in Slot #2, and Part 4 in Slot #3) use the frequency domain resource configured for Slot #0 which is configured with sub-band full duplex scheme.

FIGS. 20 and 21 illustrate exemplary resource allocation schemes for CG PUSCH transmission without repetition according to some embodiments of the present application. As described above, FIGS. 20 and 21 refer to embodiments of Solution 3, in which one frequency domain resource is indicated and a UE may adjust this frequency domain resource to adapt the frequency domain sub-band configuration according to predefined rules. There may be following three predefined rules which can be applied in Solution 3:
(1) Rule 1: an indicated resource is changed into a smaller resource by removing RB(s) crossing multiple frequency domain sub-bands configured with different transmission directions. Some embodiments of FIG. 20 refer to Rule 1 applied in Solution 3
(2) Rule 2: in a slot configured with sub-band full duplex scheme, a UE interprets the frequency domain resource indication in the UL frequency domain sub-band, which means the RB indexing for resource allocation is determined within the UE's UL frequency domain sub-band. Otherwise, the UE interprets the frequency domain resource indication in the BWP. Some embodiments of FIG. 21 refer to Rule 2 applied in Solution 3.
(3) Rule 3: a UE interprets the frequency domain resource indication as normal firstly, and if frequency domain resource crosses the boundary, the UE re-interprets the frequency domain resource indication in the UL frequency domain sub-band. Some other embodiments of FIG. 21 refer to Rule 3 applied in Solution 3.

In the embodiments of FIG. 20 of Rule 1 applied in Solution 3, for CG type 1 PUSCH transmission without repetition, resource assignments applied for the transmission could be provided by higher layer parameter frequencyDomainAllocation. For CG type 2 PUSCH transmission without repetition, resource assignments applied for the CG type 2 PUSCH transmission could be provided by a resource allocation field in the detected PDCCH DCI. In a case that a slot is configured with sub-band full duplex and the RBs of the indicated resource cross multiple frequency domain sub-bands configured with different transmission directions, a UE may adjust the indicated resource by removing the RBs crossing multiple frequency domain sub-bands configured with different transmission directions. For example, as shown in FIG. 20, in Slot #0 and Slot #1 which are configured with sub-band full duplex scheme, one frequency domain resource was used for PUSCH 1 transmission and PUSCH 2 transmission by removing the RBs in the sub-bands configured with downlink transmission direction; and in normal Slot #2 which is not configured with sub-band full duplex scheme, the indicated frequency domain resource is used for PUSCH 3 transmission. That is, in Slot #0 and Slot #1 configured with sub-band full duplex scheme, the frequency domain resource for PUSCH 1 transmission and PUSCH 2 transmission is determined as only including RB(s) configured with an uplink transmission direction.

In the embodiments of FIG. 21 of Rule 2 applied in Solution 3, for CG type 1 PUSCH transmission without repetition, resource assignments applied for the CG type 1 PUSCH transmission could be provided by higher layer parameter frequencyDomainAllocation. For CG type 2 PUSCH transmission without repetition, resource assignments applied for the CG type 2 PUSCH transmission could be provided by a resource allocation field in the detected PDCCH DCI. For a slot configured with sub-band full duplex, the frequency domain resource is determined according to the low N bits from the resource assignments, and N could be decided according the number of RBs of the UL frequency domain sub-band and the indication granularity of indication, which could be configured by a BS or predefined by a standard specification. For other slots, the frequency domain resource could be determined according the current technology. For example, as shown in FIG. 21, although a BS indicates the same resource assignment for Slot #0 and Slot #1 and Slot #2, in Slot #0 and Slot #1 which are configured with sub-band full duplex scheme, the frequency domain resource used for PUSCH 1 transmission and PUSCH 2 transmission only including RB(s) configured with an uplink transmission direction; and in normal Slot #2 which is not configured with sub-band full duplex scheme, the other frequency domain resource is used for PUSCH 3 transmission. That is, in Slot #0 and Slot #1 configured with sub-band full duplex scheme, the frequency domain resource for PUSCH 1 transmission and PUSCH 2 transmission is determined as only including RB(s) configured with an uplink transmission direction.

In the embodiments of FIG. 21 of Rule 3 applied in Solution 3, for CG type 1 PUSCH transmission without repetition, resource assignments applied for the transmission could be provided by higher layer parameter, e.g., frequencyDomainAllocation. For CG type 2 PUSCH transmission without repetition, resource assignments applied for the transmission could be provided by a resource allocation field in the detected PDCCH DCI. For some slot configured with sub-band full duplex, if a UE found that the indicated resource crosses sub-band boundary, the frequency domain resource is determined according to the low N bits from the resource assignments, where N could be decided according the number of RBs of the UL frequency domain sub-band and the indication granularity of indication, which could be configured by a BS or predefined by a standard specification. For example, as shown in FIG. 21, although a BS indicates the same resource assignment for Slot #0, Slot #1, and Slot #2, in Slot #0 and Slot #1 configured with sub-band full duplex scheme, a UE found that the indicate resource crosses sub-band boundary, so the frequency domain resource used for PUSCH 1 transmission and PUSCH 2 transmission only include RB(s) configured with an uplink transmission direction; and in normal Slot #2 which is not configured with sub-band full duplex scheme, the indicate resource is used for PUSCH 3 transmission.

Some other embodiments of the present application provide Solution 3. In Solution 3, one frequency domain resource is indicated, and this frequency domain resource is adjusted by a UE to adapt the frequency domain sub-band configuration according to predefined rules. The embodiments for PUSCH repetition Type A or Type B or enhanced PUSCH repetition Type A, or TBOMS are similar to the embodiments of Solution 2. Different from Solution 2, two resources used for transmission in Solution 3 include one resource indicated by a BS and the other resource re-interpreted by a UE according to the indicated resource and the predefined rules.

Specifically, some embodiments of the present application assume that a BS configures different transmission directions for sub-bands in some slots by higher layer signaling or dynamic signaling, and thus, a UE knows whether a slot is configured with sub-band full duplex or not and the transmission direction of each sub-band. However, sometimes, a BS may not configure different transmission directions for sub-bands in some slots by higher layer signaling or dynamic signaling, and thus, a UE does not know whether a slot is configured with sub-band full duplex or not and the transmission direction of each sub-band. In this scenario, for this invention, a time domain pattern should be pre-determined to the UE, and the time domain pattern could be pre-defined in the 3GPP specification or could be indicated by a BS using higher layer signaling or DCI. For Solution 1, this time pattern indicates whether to drop the transmission in each time unit. For Solution 2 or Solution 3, this time pattern indicates which frequency resource should be used for each time unit.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A user equipment (UE) for wireless communication, comprising:
at least one memory; and
at least one processor coupled with the at least one memory and configured to cause the UE to:
receive, from a network node, at least one indication of at least one frequency domain transmission resource; and
determine a first frequency domain resource in a first time unit according to a type of the first time unit,
wherein the first frequency domain resource is used for transmitting a first physical uplink shared channel (PUSCH) transmission,
wherein the first frequency domain resource is associated with the at least one frequency domain transmission resource, and
wherein the type of the first time unit comprises a first time unit type or a second time unit type.

2. The UE of claim 1, wherein the at least one processor is further configured to receive a first indication indicating a type of at least one time unit, wherein the at least one time unit comprises the first time unit.

3. The UE of claim 1, wherein:
a time unit has the first time unit type when the time unit corresponds to all frequency domain sub-bands configured with only one transmission direction, wherein the only one transmission direction is: a downlink transmission direction, an uplink transmission direction, or a flexible transmission direction; or
a time unit has the second time unit type when the time unit corresponds to at least two frequency domain sub-bands configured with different transmission directions, wherein each transmission direction within the different transmission directions is: the downlink transmission direction, the uplink transmission direction, or the flexible transmission direction.

4. The UE of claim 1, wherein:
in response to the at least one indication including one indication, the one indication is used to indicate a first frequency domain transmission resource and a second frequency domain transmission resource; or
in response to the at least one indication including a second indication and a third indication, the second indication is used to indicate the first frequency domain transmission resource, and the third indication is used to indicate the second frequency domain transmission resource.

5. The UE of claim 4, wherein:
the first frequency domain transmission resource is associated with the first time unit type; and
the second frequency domain transmission resource is associated with the second time unit type.

6. The UE of claim 5, wherein:
if the type of the first time unit is the first time unit type, the first frequency domain resource is determined as the first frequency domain transmission resource; or
if the type of the first time unit is the second time unit type, the first frequency domain resource is determined as the second frequency domain transmission resource.

7. The UE of claim 1, wherein the first PUSCH transmission carries:
a repetition of a PUSCH transmission with PUSCH repetition Type A; or
a repetition of a PUSCH transmission with enhanced PUSCH repetition Type A; or
a nominal repetition of a PUSCH transmission with PUSCH repetition Type B; or
an actual repetition of a PUSCH transmission with PUSCH repetition Type B; or
a transmission part of a PUSCH transmission with transmission block processing over multi-slot (TBOMS).

8. A network node for wireless communication, comprising:
at least one memory; and
at least one processor coupled with the at least one memory and configured to cause the network node to:
transmit, to a user equipment (UE), at least one indication of at least one frequency domain transmission resource; and
determine a first frequency domain resource in a first time unit according to a type of the first time unit,
wherein the first frequency domain resource is used for receiving a first physical uplink share channel (PUSCH) transmission,
wherein the first frequency domain resource is associated with the at least one frequency domain transmission resource, and
wherein the type of the first time unit comprises a first time unit type or a second time unit type.

9. The network node of claim 8, wherein the processor is configured:
to transmit a first indication indicating a type of at least one time unit, wherein the at least one time unit comprises the first time unit.

10. The network node of claim 8, wherein:
a time unit has the first time unit type when the time unit corresponds to all frequency domain sub-bands configured with only one transmission direction, wherein the only one transmission direction is: the downlink transmission direction, the uplink transmission direction, or the flexible transmission direction; or
a time unit has the second time unit type when the time unit corresponds to at least two frequency domain sub-bands configured with different transmission directions, wherein each transmission direction within the different transmission directions is: a downlink transmission direction, an uplink transmission direction, or a flexible transmission direction.

11. The network node of claim 8, wherein:
in response to the at least one indication including one indication, the one indication is used to indicate a first frequency domain transmission resource and a second frequency domain transmission resource; or
in response to the at least one indication including a second indication and a third indication, the second indication is used to indicate the first frequency domain transmission resource, and the third indication is used to indicate the second frequency domain transmission resource.

12. The network node of claim 11, wherein:
the first frequency domain transmission resource is associated with the first time unit type; and
the second frequency domain transmission resource is associated with the second time unit type.

13. The network node of claim 12, wherein:
if the type of the first time unit is the first time unit type, the first frequency domain resource is determined as the first frequency domain transmission resource; or
if the type of the first time unit is the second time unit type, the first frequency domain resource is determined as the second frequency domain transmission resource.

14. The network node of claim 8, wherein the first PUSCH transmission carries:
a repetition of a PUSCH transmission with PUSCH repetition Type A; or
a repetition of a PUSCH transmission with enhanced PUSCH repetition Type A; or
a nominal repetition of a PUSCH transmission with PUSCH repetition Type B; or
an actual repetition of a PUSCH transmission with PUSCH repetition Type B; or
a transmission part of a PUSCH transmission with transmission block processing over multi-slot (TBOMS).

15. A method performed by a user equipment (UE), the method comprising:
receiving, from a network node, at least one indication of at least one frequency domain transmission resource; and
determining a first frequency domain resource in a first time unit according to a type of the first time unit,
wherein the first frequency domain resource is used for transmitting a first physical uplink share channel (PUSCH) transmission,
wherein the first frequency domain resource is associated with the at least one frequency domain transmission resource, and
wherein the type of the first time unit comprises a first time unit type or a second time unit type.

16. A processor for wireless communication, comprising:
at least one controller coupled with at least one memory and configured to cause the processor to:
receive, from a network node, at least one indication of at least one frequency domain transmission resource; and
determine a first frequency domain resource in a first time unit according to a type of the first time unit,
wherein the first frequency domain resource is used for transmitting a first physical uplink shared channel (PUSCH) transmission,
wherein the first frequency domain resource is associated with the at least one frequency domain transmission resource, and
wherein the type of the first time unit comprises a first time unit type or a second time unit type.

17. The processor of claim 16, wherein the at least one controller is further configured to cause the processor to receive a first indication indicating a type of at least one time unit, wherein the at least one time unit comprises the first time unit.

18. The processor of claim 16, wherein:
a time unit has the first time unit type when the time unit corresponds to all frequency domain sub-bands configured with only one transmission direction, wherein the only one transmission direction is: a downlink transmission direction, an uplink transmission direction, or a flexible transmission direction; or
a time unit has the second time unit type when the time unit corresponds to at least two frequency domain sub-bands configured with different transmission directions, wherein each transmission direction within the different transmission directions is: the downlink transmission direction, the uplink transmission direction, or the flexible transmission direction.

19. The processor of claim 16, wherein:
in response to the at least one indication including one indication, the one indication is used to indicate a first frequency domain transmission resource and a second frequency domain transmission resource; or
in response to the at least one indication including a second indication and a third indication, the second indication is used to indicate the first frequency domain transmission resource, and the third indication is used to indicate the second frequency domain transmission resource.

20. The processor of claim 16, wherein the first PUSCH transmission carries:
a repetition of a PUSCH transmission with PUSCH repetition Type A; or
a repetition of a PUSCH transmission with enhanced PUSCH repetition Type A; or
a nominal repetition of a PUSCH transmission with PUSCH repetition Type B; or
an actual repetition of a PUSCH transmission with PUSCH repetition Type B; or
a transmission part of a PUSCH transmission with transmission block processing over multi-slot (TBOMS).
